(19) United States
(12) Patent Application Publication
(10) Pub. No.: US 2026/0262080 A1
(43) Pub. Date: Sep. 3, 2026

(54) MAPPING TECHNIQUES FOR PARTIAL SIDELINK TRANSMISSIONS USING WIDEBAND OPERATIONS

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Chih-Hao LIU, San Diego, CA (US); Shaozhen GUO, Beijing (CN); Siyi CHEN, Beijing (CN); Hao XU, Beijing (CN)

(21) Appl. No.: 18/876,026

(22) PCT Filed: Aug. 9, 2022
(86) PCT No.: PCT/CN2022/111026

§ 371 Date: Dec. 17, 2024

(51) Int. Cl. H04W 74/0808

(52) U.S. Cl. CPC H04W 74/0808

(57) ABSTRACT

Methods, systems, and devices for wireless communication are described. A user equipment (UE) may map a physical sidelink shared channel (PSSCH) transmission to a carrier of a shared radio frequency spectrum band for performing wideband operations, the carrier including a quantity of listen-before-talk (LBT) sub-bands, where the wideband operations are associated with sidelink communications using bandwidth that exceeds a threshold bandwidth. The UE may perform respective LBT procedures for the quantity of LBT sub-bands, and may determine whether to transmit a portion of the PSSCH transmission via a subset of the LBT sub-bands based on at least one LBT procedure of the respective LBT procedures failing.

### CROSS REFERENCE

The present Application is a 371 national phase filing of International PCT Application No. PCT/CN2022/111026 by YANG et al., entitled “MAPPING TECHNIQUES FOR PARTIAL SIDELINK TRANSMISSIONS USING WIDEBAND OPERATIONS,” filed Aug. 9, 2022, which is assigned to the assignee hereof, and which is expressly incorporated by reference in its entirety herein.

### FIELD OF TECHNOLOGY

The following relates to wireless communication, including mapping techniques for partial sidelink transmissions using wideband operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some cases, a wireless communications system may support communications using a shared radio frequency spectrum band.

### SUMMARY

The described techniques relate to improved methods, systems, devices, and apparatuses that support mapping techniques for partial sidelink transmissions using wideband operations. For example, the described techniques provide for a framework for transmitting a partial sidelink message using one or more portions of a sidelink carrier (e.g., a wideband carrier). In some examples, a user equipment (UE) may map a physical sidelink shared channel (PSSCH) to a carrier of a shared radio frequency spectrum band for performing wideband operations, where the carrier includes multiple listen-before-talk (LBT) sub-bands. In such cases, the multiple LBT sub-bands of the carrier may be treated as a single band when mapping the PSSCH. In other examples, the UE may map the PSSCH to each LBT sub-band of the multiple LBT sub-bands for performing the wideband operations. Here, different redundancy versions of a transport block associated with the PSSCH may be mapped to respective LBT sub-bands. Additionally, or alternatively, different transport blocks associated with the PSSCH may be mapped to the respective LBT sub-bands. In some aspects, different code block groups associated with the PSSCH may be mapped to the respective LBT sub-bands. In any case, the UE may perform multiple LBT procedures for the LBT sub-bands, and one or more LBT procedures may fail. The UE may determine whether to transmit a portion of the sidelink message based on the one or more LBT procedure failures and the mapping of the PSSCH.

A method for wireless communication at a UE is described. The method may include mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth, performing respective LBT procedures for the set of multiple LBT sub-bands, and determining whether to transmit a portion of the PSSCH transmission via a subset of LBT sub-bands of the set of multiple LBT sub-bands based on at least one LBT procedure of the respective LBT procedures failing.

An apparatus for wireless communication at a UE is described. The apparatus may include a processor, memory coupled with the processor, and instructions stored in the memory. The instructions may be executable by the processor to cause the apparatus to map a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth, perform respective LBT procedures for the set of multiple LBT sub-bands, and determine whether to transmit a portion of the PSSCH transmission via a subset of LBT sub-bands of the set of multiple LBT sub-bands based on at least one LBT procedure of the respective LBT procedures failing.

Another apparatus for wireless communication at a UE is described. The apparatus may include means for mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth, means for performing respective LBT procedures for the set of multiple LBT sub-bands, and means for determining whether to transmit a portion of the PSSCH transmission via a subset of LBT sub-bands of the set of multiple LBT sub-bands based on at least one LBT procedure of the respective LBT procedures failing.

A non-transitory computer-readable medium storing code for wireless communication at a UE is described. The code may include instructions executable by a processor to map a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth, perform respective LBT procedures for the set of multiple LBT sub-bands, and determine whether to transmit a portion of the PSSCH transmission via a subset of LBT sub-bands of the set of multiple LBT sub-bands based on at least one LBT procedure of the respective LBT procedures failing.

In some examples of the method, apparatuses, and non-transitory computer-readable medium described herein, determining whether to transmit the portion of the PSSCH transmission may include operations, features, means, or instructions for determining whether to transmit the portion of the PSSCH transmission based on first sidelink control information and second sidelink control information associated with the PSSCH transmission both being included in a first LBT sub-band of the set of multiple LBT sub-bands.

Some examples of the method, apparatuses, and non-transitory computer-readable medium described herein may further include operations, features, means, or instructions for transmitting the portion of the PSSCH transmission via the subset of LBT sub-bands, the subset of LBT sub-bands including the first LBT sub-band, where the portion of the PSSCH transmission may be transmitted based on successful LBT procedures for each LBT sub-band of the subset of LBT sub-bands, and where the at least one LBT procedure that failed corresponds to one or more LBT sub-bands that may be different from LBT sub-bands of the subset of LBT sub-bands.

In some examples of the method, apparatuses, and non-transitory computer-readable medium described herein, the portion of the PSSCH transmission may be transmitted based on a quantity of LBT sub-bands of the subset of LBT sub-bands satisfying a threshold quantity of LBT sub-bands having a successful LBT procedure.

Some examples of the method, apparatuses, and non-transitory computer-readable medium described herein may further include operations, features, means, or instructions for dropping the PSSCH transmission based on the first LBT sub-band corresponding to the at least one LBT procedure that failed.

In some examples of the method, apparatuses, and non-transitory computer-readable medium described herein, determining whether to transmit the portion of the PSSCH transmission may include operations, features, means, or instructions for determining whether to transmit the portion of the PSSCH transmission based on first sidelink control information and second sidelink control information associated with the PSSCH transmission being included in each LBT sub-band of the set of multiple LBT sub-bands.

Some examples of the method, apparatuses, and non-transitory computer-readable medium described herein may further include operations, features, means, or instructions for transmitting the portion of the PSSCH transmission via the subset of LBT sub-bands based on a first quantity of LBT sub-bands of the subset of LBT sub-bands satisfying a threshold quantity of LBT sub-bands having a successful LBT procedure.

Some examples of the method, apparatuses, and non-transitory computer-readable medium described herein may further include operations, features, means, or instructions for dropping the PSSCH transmission based on a second quantity of LBT sub-bands of the set of multiple LBT sub-bands failing to satisfy a threshold quantity of LBT sub-bands having a successful LBT procedure.

In some examples of the method, apparatuses, and non-transitory computer-readable medium described herein, determining whether to transmit the portion of the PSSCH transmission may include operations, features, means, or instructions for determining whether to transmit the portion of the PSSCH transmission based on first sidelink control information associated with the PSSCH transmission being included in a first LBT sub-band of the set of multiple LBT sub-bands and second sidelink control information associated with the PSSCH transmission being included in two or more LBT sub-bands of the set of multiple LBT sub-bands.

Some examples of the method, apparatuses, and non-transitory computer-readable medium described herein may further include operations, features, means, or instructions for transmitting the portion of the PSSCH transmission via the subset of LBT sub-bands, the subset of LBT sub-bands including the first LBT sub-band, where the portion of the PSSCH transmission may be transmitted based on successful LBT procedures for each LBT sub-band of the subset of LBT sub-bands and a threshold percentage of the second sidelink control information being included in LBT sub-bands having the successful LBT procedures.

In some examples of the method, apparatuses, and non-transitory computer-readable medium described herein, the portion of the PSSCH transmission may be transmitted based on a quantity of LBT sub-bands of the subset of LBT sub-bands satisfying a threshold quantity of LBT sub-bands having a successful LBT procedure.

Some examples of the method, apparatuses, and non-transitory computer-readable medium described herein may further include operations, features, means, or instructions for dropping the PSSCH transmission based on a threshold percentage of the second sidelink control information being included in the at least one LBT sub-band that failed the LBT procedure.

In some examples of the method, apparatuses, and non-transitory computer-readable medium described herein, mapping the PSSCH transmission may include operations, features, means, or instructions for mapping the PSSCH transmission across the set of multiple LBT sub-bands of the carrier, where the PSSCH transmission may be mapped based on a frequency index of the carrier followed by a time index of the carrier.

A method for wireless communication is described. The method may include mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth, performing respective LBT procedures for the set of multiple LBT sub-bands, and determining whether to transmit a portion of the PSSCH transmission via a subset of LBT sub-bands of the set of multiple LBT sub-bands based on at least one LBT procedure of the respective LBT procedures failing.

An apparatus for wireless communication is described. The apparatus may include a processor, memory coupled with the processor, and instructions stored in the memory. The instructions may be executable by the processor to cause the apparatus to map a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth, perform respective LBT procedures for the set of multiple LBT sub-bands, and determine whether to transmit a portion of the PSSCH transmission via a subset of LBT sub-bands of the set of multiple LBT sub-bands based on at least one LBT procedure of the respective LBT procedures failing.

Another apparatus for wireless communication is described. The apparatus may include means for mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth, means for performing respective LBT procedures for the set of multiple LBT sub-bands, and means for determining whether to transmit a portion of the PSSCH transmission via a subset of LBT sub-bands of the set of multiple LBT sub-bands based on at least one LBT procedure of the respective LBT procedures failing.

A non-transitory computer-readable medium storing code for wireless communication is described. The code may include instructions executable by a processor to map a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth, perform respective LBT procedures for the set of multiple LBT sub-bands, and determine whether to transmit a portion of the PSSCH transmission via a subset of LBT sub-bands of the set of multiple LBT sub-bands based on at least one LBT procedure of the respective LBT procedures failing.

In some examples of the method, apparatuses, and non-transitory computer-readable medium described herein, mapping the PSSCH transmission may include operations, features, means, or instructions for mapping a different redundancy version of a transport block associated with the PSSCH transmission to respective LBT sub-bands of the set of multiple LBT sub-bands, where the mapping may be based on a modulation and coding scheme for the PSSCH transmission.

In some examples of the method, apparatuses, and non-transitory computer-readable medium described herein, determining whether to transmit the portion of the PSSCH transmission may include operations, features, means, or instructions for determining whether to transmit the portion of the PSSCH transmission based on first sidelink control information and second sidelink control information associated with the PSSCH transmission both being included in a first LBT sub-band of the set of multiple LBT sub-bands.

Some examples of the method, apparatuses, and non-transitory computer-readable medium described herein may further include operations, features, means, or instructions for transmitting the portion of the PSSCH transmission via the subset of LBT sub-bands, the subset of LBT sub-bands including the first LBT sub-band, where the portion of the PSSCH transmission may be transmitted based on successful LBT procedures for each LBT sub-band of the subset of LBT sub-bands, and where the at least one LBT procedure that failed corresponds to one or more LBT sub-bands that may be different from LBT sub-bands of the subset of LBT sub-bands.

Some examples of the method, apparatuses, and non-transitory computer-readable medium described herein may further include operations, features, means, or instructions for dropping the PSSCH transmission based on the first LBT sub-band corresponding to the at least one LBT procedure that failed.

In some examples of the method, apparatuses, and non-transitory computer-readable medium described herein, determining whether to transmit the portion of the PSSCH transmission may include operations, features, means, or instructions for determining whether to transmit the portion of the PSSCH transmission based on first sidelink control information associated with the PSSCH transmission being included in a first LBT sub-band of the set of multiple LBT sub-bands and second sidelink control information associated with the PSSCH transmission being included in two or more LBT sub-bands of the set of multiple LBT sub-bands.

Some examples of the method, apparatuses, and non-transitory computer-readable medium described herein may further include operations, features, means, or instructions for transmitting the portion of the PSSCH transmission via the subset of LBT sub-bands, the subset of LBT sub-bands including the first LBT sub-band, where the portion of the PSSCH transmission may be transmitted based on successful LBT procedures for each LBT sub-band of the subset of LBT sub-bands and a threshold percentage of the second sidelink control information being included in LBT sub-bands having the successful LBT procedures.

Some examples of the method, apparatuses, and non-transitory computer-readable medium described herein may further include operations, features, means, or instructions for dropping the PSSCH transmission based on a threshold percentage of the second sidelink control information being included in the at least one LBT sub-band that failed the LBT procedure.

In some examples of the method, apparatuses, and non-transitory computer-readable medium described herein, determining whether to transmit the portion of the PSSCH transmission may include operations, features, means, or instructions for determining whether to transmit the portion of the PSSCH transmission based on first sidelink control information and second sidelink control information associated with the PSSCH transmission being included in each LBT sub-band of the set of multiple LBT sub-bands.

Some examples of the method, apparatuses, and non-transitory computer-readable medium described herein may further include operations, features, means, or instructions for transmitting the portion of the PSSCH transmission via the subset of LBT sub-bands based on successful LBT procedures for LBT sub-bands of the subset of LBT sub-bands.

Some examples of the method, apparatuses, and non-transitory computer-readable medium described herein may further include operations, features, means, or instructions for dropping the PSSCH transmission based on failed LBT procedures for LBT sub-bands of the set of multiple LBT sub-bands.

In some examples of the method, apparatuses, and non-transitory computer-readable medium described herein, the different redundancy versions of the transport block may be mapped to the respective LBT sub-bands based on a predefined mapping rule.

Some examples of the method, apparatuses, and non-transitory computer-readable medium described herein may further include operations, features, means, or instructions for transmitting, in each LBT sub-band of the set of multiple LBT sub-bands, first sidelink control information and second sidelink control information associated with the PSSCH transmission, the second sidelink control information indicating a redundancy version corresponding to the respective LBT sub-band that includes the second sidelink control information.

In some examples of the method, apparatuses, and non-transitory computer-readable medium described herein, mapping the PSSCH transmission may include operations, features, means, or instructions for mapping a different transport block associated with the PSSCH transmission to respective LBT sub-bands of the set of multiple LBT sub-bands.

In some examples of the method, apparatuses, and non-transitory computer-readable medium described herein, each LBT sub-band of the set of multiple LBT sub-bands includes a respective set of first sidelink control information and second sidelink control information associated with the PSSCH transmission and each set of first sidelink control information and second sidelink control information indicates a respective transport block associated with an LBT sub-band.

In some examples of the method, apparatuses, and non-transitory computer-readable medium described herein, a first LBT sub-band of the set of multiple LBT sub-bands includes first sidelink control information and each LBT sub-band of the set of multiple LBT sub-bands includes a respective second sidelink control information, the first sidelink control information indicating a modulation and coding scheme and a resource allocation for the carrier, and each second sidelink control information indicating one or more information fields for a respective transport block of the one or more transport blocks.

In some examples of the method, apparatuses, and non-transitory computer-readable medium described herein, the resource allocation may be based on a quantity of LBT sub-bands of the set of multiple sub-bands or a ratio of available frequency resources of the carrier.

In some examples of the method, apparatuses, and non-transitory computer-readable medium described herein, the second sidelink control information indicates a resource allocation for each LBT sub-band of the set of multiple LBT sub-bands.

In some examples of the method, apparatuses, and non-transitory computer-readable medium described herein, mapping the PSSCH transmission may include operations, features, means, or instructions for mapping a respective sets of code block groups of a transport block associated with the PSSCH transmission to respective LBT sub-bands of the set of multiple LBT sub-bands.

In some examples of the method, apparatuses, and non-transitory computer-readable medium described herein, a first LBT sub-band of the set of multiple LBT sub-bands includes first sidelink control information and each LBT sub-band of the set of multiple LBT sub-bands includes a respective second sidelink control information and the method, apparatuses, and non-transitory computer-readable medium may include further operations, features, means, or instructions for transmitting the portion of the PSSCH transmission via the subset of LBT sub-bands based on successful LBT procedures for the first LBT sub-band, the subset of LBT sub-bands including the first LBT sub-band.

In some examples of the method, apparatuses, and non-transitory computer-readable medium described herein, a threshold quantity of code block groups in each set of code block groups may be based on an integer multiple of a quantity of LBT sub-bands of the set of multiple LBT sub-bands.

Some examples of the method, apparatuses, and non-transitory computer-readable medium described herein may further include operations, features, means, or instructions for transmitting at least the portion of the PSSCH transmission and receiving, via one or more physical sidelink feedback channels, a feedback message that indicates whether the PSSCH transmission was decoded by another UE, where the feedback message includes a single bit or multiple bits to indicate whether the PSSCH transmission was decoded based on the mapping of the PSSCH transmission.

In some examples of the method, apparatuses, and non-transitory computer-readable medium described herein, the feedback message includes the multiple bits and the multiple bits may be included in a single physical sidelink feedback channel.

In some examples of the method, apparatuses, and non-transitory computer-readable medium described herein, the feedback message includes the multiple bits and each bit of the multiple bits may be included in a respective physical sidelink feedback channel.

In some examples of the method, apparatuses, and non-transitory computer-readable medium described herein, receiving the feedback message may include operations, features, means, or instructions for receiving the feedback message via a set of physical sidelink feedback channel resources that may be from a resource pool that may be based on the wideband operations.

In some examples of the method, apparatuses, and non-transitory computer-readable medium described herein, receiving the feedback message may include operations, features, means, or instructions for receiving the feedback message via a respective sets of physical sidelink feedback channel resources that may be from different resource pools corresponding to the respective LBT sub-bands of the set of multiple LBT sub-bands.

### BRIEF DESCRIPTION OF THE DRAWINGS

FIG. 1 illustrates an example of a wireless communications system that supports mapping techniques for partial sidelink transmissions using wideband operations in accordance with one or more aspects of the present disclosure.

FIG. 2 illustrates an example of a wireless communication system that supports mapping techniques for partial sidelink transmissions using wideband operations in accordance with one or more aspects of the present disclosure.

FIGS. 3A, 3B, 3C, 4A, 4B, 5A, 5B, 6A, 6B, 7, and 8A, 8B, and 8C each illustrate an example of a wideband carrier diagram that supports mapping techniques for partial sidelink transmissions using wideband operations in accordance with one or more aspects of the present disclosure.

FIG. 9 illustrates an example of a process flow in a system that supports mapping techniques for partial sidelink transmissions using wideband operations in accordance with one or more aspects of the present disclosure.

FIGS. 10 and 11 show block diagrams of devices that support mapping techniques for partial sidelink transmissions using wideband operations in accordance with one or more aspects of the present disclosure.

FIG. 12 shows a block diagram of a communications manager that supports mapping techniques for partial sidelink transmissions using wideband operations in accordance with one or more aspects of the present disclosure.

FIG. 13 shows a diagram of a system including a device that supports mapping techniques for partial sidelink transmissions using wideband operations in accordance with one or more aspects of the present disclosure.

FIGS. 14 through 17 show flowcharts illustrating methods that support mapping techniques for partial sidelink transmissions using wideband operations in accordance with one or more aspects of the present disclosure.

### DETAILED DESCRIPTION

Some wireless communications systems may include communication devices, such as user equipments (UEs) or network entities, that support wireless communications using one or more radio access technologies (RATs). For example, the communication devices may support wireless communications using one or multiple cellular RATs, such as fourth generation (4G) systems (e.g., Long Term Evolution (LTE) systems), and fifth generation (5G) systems, which may be referred to as New Radio (NR) systems. In some examples, the wireless communications system may support communications using an unlicensed radio frequency spectrum band that may be shared with one or more other RATs, such as Wi-Fi, or Bluetooth, or both, among other examples. In such examples, prior to transmitting communications using the unlicensed radio frequency spectrum band, a communication device (e.g., a network entity, a UE) may perform a channel access procedure, such as to gain access to a communication channel (e.g., frequency resources) of the unlicensed radio frequency spectrum band. The communication device may support wideband operations in which a carrier (e.g., a wideband carrier) of the unlicensed radio frequency spectrum band may include multiple bandwidths. In some examples, the communication device may perform wideband operations using a network access link (e.g., a Uu interface). In such examples, the communication device may perform a channel access procedure for multiple bandwidths of the carrier and may transmit communications using bandwidths in which the respective channel access procedure is successful.

In some other examples, the communication device may perform wideband operations using a sidelink (e.g., a PC5 interface). In such examples, the communication device may transmit sidelink control information (SCI) that may include information regarding resource allocation for subsequent sidelink transmissions (e.g., data transmissions). For example, the SCI may include an indication (e.g., a reservation announcement) of one or more resources that the UE may intend to use (e.g., may have reserved) for transmitting one or more portions of sidelink message using one or more bandwidths of the carrier. In some examples, the communication device may use a particular bandwidth of the wideband carrier to transmit the SCI. As such, if a channel access procedure performed for the bandwidth in which the SCI is to be transmitted fails, the SCI may not be transmitted at the communication device. In such examples, another communication device (e.g., a receiving device) may be incapable of determining which resources are to be used at the communication device for transmitting the one or more portions of the sidelink message.

In some cases, when the UE uses a wideband carrier of a shared radio frequency spectrum band (e.g., an unlicensed radio frequency spectrum band) for a sidelink transmission and one or more of the channel access procedures (e.g., listen-before-talk (LBT) procedures) fail, the UE may transmit a partial transmission of the sidelink transmission. However, in some cases, the partial transmission may not include one or more SCIs, which may affect the ability of the receiving device (e.g., a receiving UE) to receive and decode the transmission.

Various aspects of the present disclosure generally relate to techniques for partial sidelink transmission using wideband operations, and more specifically, to a framework for transmitting a partial sidelink message using one or more portions of a wideband carrier. For example, a UE may be configured with one or more rules for performing wideband operations using an unlicensed sidelink channel (e.g., a sidelink channel of the shared radio frequency spectrum band). In such cases, PSSCH may be mapped to a wideband carrier including multiple LBT sub-bands, which may result in various rules that define when the UE may transmit a partial PSSCH transmission to another UE using shared radio frequency spectrum. For example, in a first technique, the PSSCH may be mapped to the wideband carrier such that the PSSCH is mapped first across frequency resources of the carrier (e.g., in increasing order of frequency indices) and then in time (e.g., using time indices of the carrier). In this case, first SCI (e.g., SCI 1) and second SCI (e.g., SCI 2) may be located in one or more LBT sub-bands within the wideband carrier, and transmission of a partial PSSCH may be based on whether an LBT procedure is successful for respective LBT sub-bands that include the SCI 1 and/or SCI 2. As an example, both SCI 1 and SCI 2 may be limited to one LBT sub-band (e.g., a “primary” LBT sub-band) of the wideband carrier, and if at least the one LBT sub-band passes LBT (e.g., LBT is successful), then the UE may transmit a partial PSSCH, for example, even if some other LBT sub-bands do not pass LBT (e.g., LBT is unsuccessful for those other LBT sub-bands). Alternatively, if the one LBT sub-band (e.g., the “primary” LBT sub-band) including both SCI 1 and SCI 2 fails the LBT procedure, the UE may not transmit a partial PSSCH and may instead drop the entire PSSCH transmission. SCI 1 and SCI 2 may also be mapped to each LBT sub-band of the multiple LBT sub-bands of the wideband carrier, and the partial PSSCH transmission may be allowed based on one or more thresholds associated with the LBT sub-bands, the SCI, or both.

Additionally, or alternatively, PSSCH may be separately mapped to each LBT sub-band. Here, various mapping options may be used, including mapping respective redundancy versions of a transport block to different LBT sub-bands, mapping respective transport blocks to different LBT sub-bands, or mapping respective code block groups of a transport block to respective LBT sub-bands, among other examples. In each case, the location of SCI 1 and SCI 2 may enable rules for transmitting a partial PSSCH based on different LBT sub-bands passing (or failing) respective LBT processes. In some cases, the UE may receive feedback from the receiving UE via a wideband sidelink feedback channel, where feedback resources including, for example, hybrid automatic repeat request (HARQ) acknowledgment (ACK) or negative acknowledgment (NACK), may be based on wideband operation or based on sub-bands of the wideband carrier.

Particular aspects of the subject matter described herein may be implemented to realize one or more of the following potential advantages. The techniques employed by the UEs may provide benefits and enhancements to the operation of the UEs, including enabling partial sidelink transmissions using a wideband carrier of an unlicensed radio frequency spectrum band. Further, techniques for partial sidelink transmission using wideband operations, as described herein, may support increased data rates, one or more spectrum efficiency enhancements, and increased resource utilization, thereby improving throughput and reliability within a wireless communication system. Such techniques may lead to improved network operations and network efficiencies, among other possible benefits.

Aspects of the disclosure are initially described in the context of wireless communications systems. Aspects of the disclosure are also described in the context of a system diagram, wideband carrier diagrams, and a process flow. Aspects of the disclosure are further illustrated by and described with reference to apparatus diagrams, system diagrams, and flowcharts that relate to mapping techniques for partial sidelink transmissions using wideband operations.

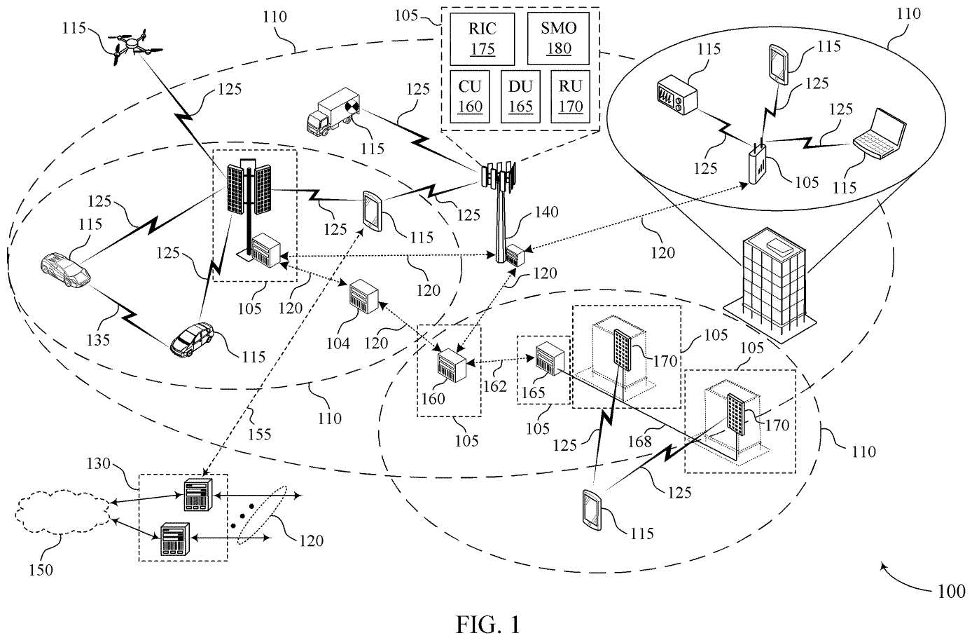

FIG. 1 illustrates an example of a wireless communications system 100 that supports mapping techniques for partial sidelink transmissions using wideband operations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support mapping techniques for partial sidelink transmissions using wideband operations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

Thus, the wireless communications system 100 may support V2X communications. For example, one or more UEs may be examples of vehicles. In some examples of V2X communications (or other types of sidelink communications), frequency domain resource allocations (e.g., allocation of communication resources in the frequency domain, allocation of frequency resources) may be indicated using SCI (e.g., SCI 1, which may be referred to as first-stage SCI, first-stage control, or the like). For example, a resource allocation unit in the frequency domain may include a sub-channel. Additionally, or alternatively, a sub-channel assignment for a sidelink transmission may be determined (e.g., at the UE 115) using a frequency resource assignment field (e.g., a frequency domain resource assignment (FDRA) field) in an associated SCI. In some examples, the FDRA may provide a frequency resource indication value (FRIV) associated with the sidelink transmission (e.g., a PSSCH transmission). One or more frequency domain resources for transmission of the PSSCH message may be determined using an SCI (e.g., transmitted using a PSCCH) associated with the PSSCH message (e.g., associated with a PSSCH used for transmission of the PSSCH message). The SCI 1 may further include other information, such as a priority, a resource reservation period, a demodulation reference signal (DMRS) pattern, a format for another SCI (e.g., SCI 2, which may be referred to as second-stage SCI, second-stage control, or the like), a modulation and coding scheme (MCS), an offset indicator, a quantity of DMRS ports, or any combination thereof, among other examples. The SCI 1 may be transmitted via a physical sidelink control channel (PSCCH) and may be associated with a PSSCH transmission.

SCI 2 may include additional information associated with the PSSCH transmission and may be indicated by SCI 1, and there may accordingly be an absence of blind decoding associated with detecting/receiving SCI 2 (e.g., a quantity of resource elements for SCI 2 may be derived from information indicated by SCI 1, and SCI 2 may have a predetermined starting location). In some aspects, SCI 2 may include a HARQ process identifier (ID) for the PSSCH transmission, a data indicator (e.g., new data indicator), a redundancy version, a source ID, a destination ID, a channel state information (CSI) request, or any combination thereof, among other examples. In some examples, the SCI 2 may be transmitted via the PSSCH. For instance, SCI 2 may be mapped to contiguous resource blocks in PSSCH beginning from a first symbol period with a PSSCH DMRS. In some aspects, the SCI 2 may be scrambled separately from a sidelink shared channel (SL-SCH) and may be transmitted using some modulation scheme (e.g., QPSK). In some cases, when an SL-SCH transmission is sent via multiple (e.g., two) layers, SCI 2 modulation symbols may be copied to each layer of the multiple layers.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support wideband operations using shared radio frequency spectrum bands (e.g., unlicensed radio frequency spectrum bands). In such cases, some devices may be capable of transmitting partial messages when channel access procedures fails for one or more sub-bands of a wideband carrier. For example, a network entity 105 (e.g., a gNB) may transmit partial downlink messages (e.g., partial physical downlink shared channel (PDSCH) messages) to a UE 115 using wideband operations, where the UE 115 may receive the partial PDSCH without performing additional functions or operations. In such examples, the network entity 105 may transmit the PDSCH message using the wideband carrier (e.g., across a single active bandwidth part) or using one or more portions of the wideband carrier in which a CCA procedure, such as an LBT procedure, may be successful (e.g., at the network entity 105). For example, a wideband carrier may include multiple portions (e.g., different portions, such as different bandwidth parts) and each portion may be associated with an LBT procedure. The network entity 105 (or another communication device) may transmit a portion of the PDSCH message (e.g., a partial PDSCH message) using a portion of a wideband carrier if an LBT procedure associated with the portion of the wideband carrier is successful. A portion of a wideband carrier (e.g., that may be associated with an LBT procedure) may be referred to as an LBT sub-band.

In some examples, a UE 115 may be scheduled to transmit an uplink message (e.g., a physical uplink shared channel (PUSCH) message) to a network entity 105 using a wideband carrier. In such examples, the UE 115 may transmit the PUSCH message using the wideband carrier (e.g., of the scheduled PUSCH message), for example if LBT procedures (e.g., each LBT procedure) associated with the LBT sub-bands are successful. Alternatively, the UE 115 may refrain from transmitting the PUSCH message (e.g., one or more portions of the PUSCH message) if an LBT procedure associated with one or more LBT sub-bands of the wideband carrier fails. Thus, a UE 115 may be unable to transmit a partial PUSCH in cases where at least one LBT sub-band used for the PUSCH transmission fails to pass a corresponding LBT procedure. In some examples, a network entity 105 may refrain from transmitting (e.g., and the UE 115 may not expect to receive) resource allocations in discontinuous LBT sub-bands within the wideband carrier.

In some cases, when the UE 115 uses a wideband carrier of an unlicensed radio frequency spectrum band for a sidelink transmission and one or more of the channel access procedures (e.g., LBT procedures) fail, the UE 115 may transmit a partial transmission of the sidelink transmission. However, in some cases, the partial transmission may not include one or more SCIs which may affect the ability of the receiving device (e.g., a receiving UE 115) to receive and decode the transmission.

The wireless communications system 100 may support the use of various rules for mapping PSSCH transmissions to a wideband carrier (e.g., for wideband operations), which may further enable the use of rules for transmitting a partial PSSCH when LBT procedures pass for respective LBT sub-bands of the wideband carrier. A UE 115 may implement a framework for transmitting a partial sidelink message using one or more portions of a wideband carrier. For example, the UE 115 may be configured with one or more rules for performing wideband operations using an unlicensed sidelink channel (e.g., a sidelink channel of the shared radio frequency spectrum band). In some cases, the UE 115 may map the sidelink message to the wideband carrier, where the wideband carrier includes a plurality of sub-bands (e.g., LBT sub-bands). In some cases, the UE 115 may map the sidelink message to each sub-band of the plurality of sub-bands separately. The UE 115 may perform one or more LBT procedures for each sub-band. Based on the one or more rules for performing wideband operations using an unlicensed sidelink channel and the results of the one or more LBT procedures, the UE 115 may determine whether to transmit the partial sidelink message. In some cases, the one or more rules may be based on a successful LBT procedure of one or more sub-bands including a first SCI, a second SCI, a threshold of an SCI, or any combination thereof.

In some cases, the UE 115 may receive feedback from the receiving UE 115 via a wideband sidelink feedback channel. In some cases, feedback resources may be based on wideband operation or based on sub-bands of the wideband carrier.

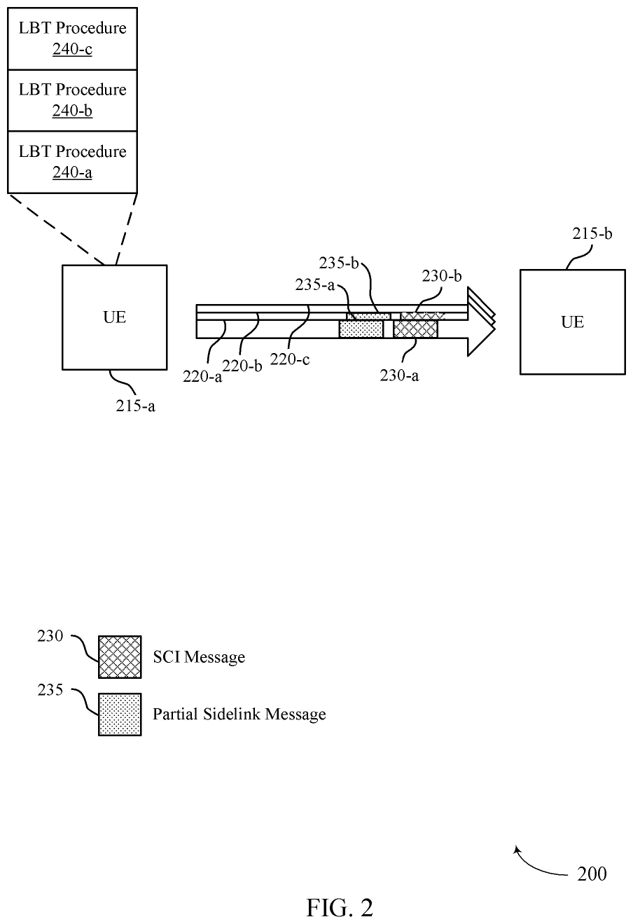

FIG. 2 illustrates an example of a wireless communication system 200 that supports mapping techniques for partial sidelink transmissions using wideband operations in accordance with one or more aspects of the present disclosure. In some examples, the wireless communication system 200 may implement aspects of the wireless communications system 100. For example, the wireless communications system 200 may include a UE 215-a and a UE 215-b, which may be examples of the UE 115 as described with reference to FIG. 2.

The wireless communications system 200 may support wireless communications using an unlicensed (e.g., shared) radio frequency spectrum. For example, to transmit a communication using the unlicensed radio frequency spectrum, the UE 215-a may perform a channel access procedure (e.g., a clear channel access procedure (CCA), an LBT procedure) to gain access to a communication channel of the unlicensed radio frequency spectrum during a duration. In such an example, the communication device may transmit the communication in response to successfully completing the CCA procedure. Additionally, or alternatively, the communication device may refrain from transmitting the communication in response to the CCA procedure failing.

As described herein, wideband operations may refer to communications using a bandwidth (e.g., a set of radio frequencies) that exceeds a threshold bandwidth (e.g., 100 MHz or some other suitable bandwidth). Additionally, or alternatively, as described herein, a bandwidth (e.g., a set of frequencies that exceeds the threshold bandwidth) may be referred to as a wideband carrier. In some cases, a wideband carrier may include multiple portions (e.g., different portions, such as different bandwidth parts) and each portion may be associated an LBT procedure. As described herein, a portion of a wideband carrier (e.g., that may be associated with an LBT procedure) may be referred to as an LBT sub-band. Although an LBT sub-band is referred to throughout the disclosure, it is to be understood that the techniques described herein may also apply to other sets of frequencies, such as other bandwidths, sub-bands, or carriers, and the examples described herein should not be considered limiting to the scope covered by the claims or the disclosure.

As illustrated in the example of FIG. 2, the wireless communications system 200 may support wideband operations for sidelink communications using shared radio frequency spectrum bands (e.g., unlicensed radio frequency spectrum bands). In some cases, a carrier (e.g., a wideband carrier) of the unlicensed radio frequency spectrum band may include multiple LBT sub-bands 220 (e.g., 20 MHz bandwidths in the 5 GHz or 6 GHz unlicensed radio frequency spectrum band) and the wireless communications system 200 may support sidelink communications using the wideband carrier (e.g., using bandwidth up to 100 MHz with 30 kHz subcarrier spacing (SCS)). In some cases, the UE 215-a may map a sidelink transmission including, for example, a physical sidelink control channel (PSCCH) transmission (e.g., a PSCCH message including SCI message 230, such as SCI message 230-a and/or SCI message 230-b) and a PSSCH transmission, to the LBT sub-bands 220 of the carrier. For example, the UE 215-a may treat the multiple LBT sub-bands 220 as a single band, and may map the PSSCH transmission based on a frequency index of the carrier followed by a time index of the carrier. In some cases, the UE 215-a may map the PSSCH transmission to each LBT sub-band 220 (e.g., the PSSCH may be mapped to each LBT sub-band 220 separately).

The UE 215-a may perform multiple LBT procedures 240 to gain access to time/frequency resources used to transmit the PSSCH for sidelink transmissions using the one or more LBT sub-bands 220 (e.g., an LBT sub-band 220-a, an LBT sub-band 220-b, an LBT sub-band 220-c). For example, the UE 215-a may perform respective LBT procedures 240 for the plurality of LBT sub-bands 220 (e.g., LBT procedure 240-a, LBT procedure 240-b, LBT procedure 240-c).

Based on at least one of the LBT procedures 240 failing, the UE 215-a may determine whether to transmit a portion of the PSSCH transmission (e.g., a partial PSSCH transmission 235) via a subset of LBT sub-bands 220 (e.g., LBT sub-band 220-a and LBT sub-band 220-b) of the plurality of LBT sub-bands 240. For example, LBT procedure 240-c may fail, but based one or more rules for performing wideband operations using an unlicensed sidelink channel, the UE 215-a may determine to transmit the partial PSSCH transmission 235 on LBT sub-band 220-a and LBT sub-band 220-b. For example, the UE 215-a may transmit a partial PSSCH transmission 235-a on LBT sub-band 220-a and a partial PSSCH transmission 235-b on LBT sub-band 220-b.

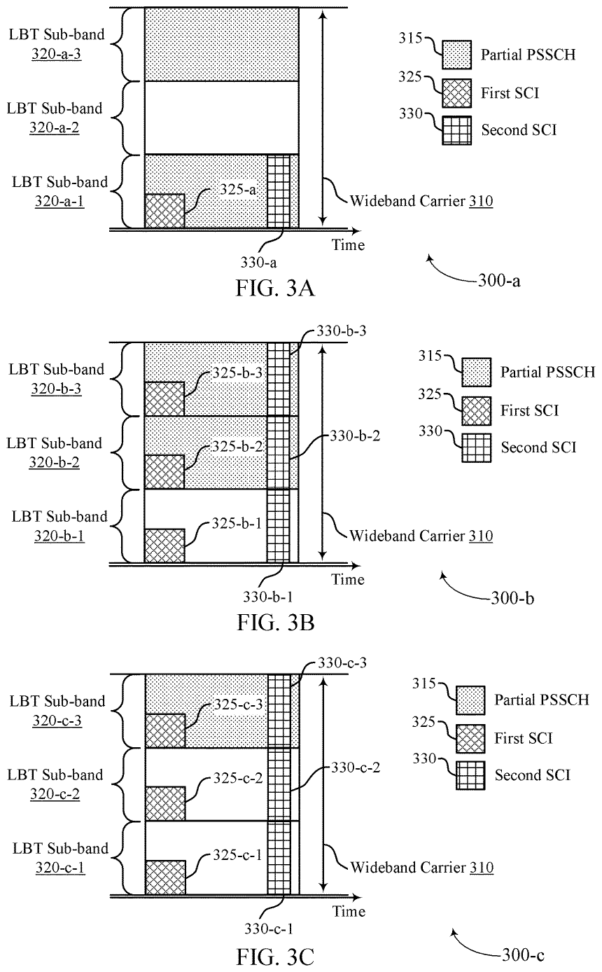

FIG. 3A illustrates an example of a wideband carrier diagram 300-a that supports mapping techniques for partial sidelink transmissions using wideband operations in accordance with one or more aspects of the present disclosure. In some examples, the wideband carrier diagram 300-a may implement aspects of the wireless communications system 100 and the wireless communications system 200. For example, the wideband carrier diagram 300-a may be implemented at a UE as described with reference to FIGS. 1 and 2.

In some examples, a wireless communications system may support wideband operations for sidelink communications using the shared radio frequency spectrum band. For example, the wireless communications system may support sidelink communication using a wideband carrier 310 that includes multiple LBT sub-bands 320 (e.g., LBT sub-band 320-a-1, LBT sub-band 320-a-2, and LBT sub-band 320-a-3). In some cases, as described with reference to FIG. 2, a PSSCH transmission may be mapped to the LBT sub-bands 320. For example, the wideband carrier 310 (including the LBT sub-bands 320) may be treated as a single band, and the PSSCH transmission may be mapped across the LBT sub-bands 320. In such examples, a first UE may perform multiple LBT procedures (e.g., respective LBT procedures for the multiple LBT sub-bands 320) to gain access to the channel for sidelink transmissions using the LBT sub-bands 320. For example, the first UE may perform a first LBT procedure associated with the LBT sub-band 320-a-1, a second LBT procedure for the LBT sub-band 320-a-2, and a third LBT procedure for LBT sub-band 320-a-3.

In some cases, the first UE may determine whether to transmit a partial PSSCH transmission 315 (e.g., a portion of the PSSCH transmission) via a subset of the LBT sub-bands 320 based on at least one LBT procedure of the respective LBT procedures failing. For example, the partial PSSCH transmission 315 may be associated with LBT sub-bands 320 corresponding to successful LBT procedures.

In some cases, the PSSCH transmission may include a first SCI 325 which may be an example of SCI 1 and a second SCI 330 which may be an example of SCI 2. In some cases, both the first SCI 325 and the second SCI 330 may be transmitted at one time and may be included in a single LBT sub-band 320. For example, SCI 325-a and SCI 330-a may be transmitted via LBT sub-band 320-a-1. Here, the LBT sub-band 320-a-1 may be considered a primary LBT sub-band 320 based on the inclusion of both SCI 1 and SCI 2 (whereas SCI 1 and/or SCI 2 may be absent from LBT sub-bands 320-a-2 and 320-a-3). In such cases, the first UE may determine whether to transmit the partial PSSCH transmission 315 based on the first SCI 325 and the second SCI 330 associated with the PSSCH transmission both being included in LBT sub-band 320-a-1 (e.g., the primary sub-band). For example, if the LBT procedure associated with LBT sub-band 320-a-1 is successful, the first UE may transmit the partial PSSCH transmission 315 via the subset of the LBT sub-bands 320. In such an example, the subset of the LBT sub-bands 320 may include LBT sub-band 320-a-1 and LBT sub-band 320-a-3, where both LBT sub-band 320-a-1 and LBT sub-band 320-a-3 are associated with successful LBT procedures. LBT sub-band 320-a-2 may be associated with a failed LBT procedure and may not be included in the subset of LBT sub-bands 320. In another example, if the LBT procedure associated with LBT sub-band 320-a-1 fails, the first UE may drop the PSSCH transmission altogether and refrain from transmitting the partial PSSCH transmission 315.

In some cases, the first UE may transmit the partial PSSCH transmission 315 based on the quantity of LBT sub-bands 320 included in the subset of LBT sub-bands 320 (e.g., the LBT sub-bands 320 to be used to transmit the partial PSSCH transmission 315) satisfying a threshold quantity of LBT sub-bands having a successful LBT procedure. For example, the threshold quantity of LBT sub-bands may correspond to the partial PSSCH transmission 315 to be transmitted (e.g., over the LBT sub-bands 320 associated with a successful LBT procedure) over the entire PSSCH transmission. If the partial PSSCH transmission 315 to be transmitted satisfies (e.g., exceeds) the threshold, the first UE may transmit the partial PSSCH transmission 315, and if the partial PSSCH transmission 315 to be transmitted fails to satisfy (e.g., is below) the threshold, the first UE may drop the PSSCH transmission altogether. In some cases, the threshold may be a predefined threshold (e.g., Y) for each MCS associated with the PSSCH transmission, and may indicate whether a partial PSSCH is allowed. For instance, the threshold may indicate a ratio of transmitted PSSCH (e.g., corresponding to sub-bands for which LBT has passed) over the total carrier 310 used for transmitting PSSCH. In such cases, if the transmitted PSSCH exceeds the threshold (e.g., Y), a partial PSSCH transmission may be allowed. Otherwise, the PSSCH transmission may be dropped.

FIG. 3B illustrates an example of a wideband carrier diagram 300-b that supports mapping techniques for partial sidelink transmissions using wideband operations in accordance with one or more aspects of the present disclosure. In some examples, the wideband carrier diagram 300-b may implement aspects of the wireless communications system 100, the wireless communications system 200 and the wideband carrier diagram 300-a. For example, the wideband carrier diagram 300-b may be implemented at a UE as described with reference to FIGS. 1 and 2.

As described with reference to FIG. 3B the wireless communications system may support sidelink communication using a wideband carrier 310 that includes multiple LBT sub-bands 320 (e.g., LBT sub-band 320-b-1, LBT sub-band 320-b-2, and LBT sub-band 320-b-3). In some cases, as described with reference to FIG. 2, a PSSCH transmission may be mapped to the LBT sub-bands 320. For example, the LBT sub-bands 320 may be treated as a single band. In such examples, a first UE may perform multiple LBT procedures (e.g., respective LBT procedures for the multiple LBT sub-bands 320) to gain access to the channel for sidelink transmissions using the LBT sub-bands 320. For example, the first UE may perform a first LBT procedure associated with the LBT sub-band 320-b-1, a second LBT procedure for the LBT sub-band 320-b-2, and a third LBT procedure for LBT sub-band 320-b-3.

In some cases, a first SCI 325 (e.g., SCI 1) and a second SCI 330 (SCI 2) (as described with reference to FIG. 3A) may be included (e.g., repeated) in each LBT sub-band 320. For example, SCI 325-b-1, SCI 325-b-2, and SCI 325-b-3 may be repetitions of the first SCI 325 while SCI 330-b-1, SCI 330-b-2, and SCI 330-b-3 may be repetitions of the second SCI 330. The first UE may determine whether to transmit a partial PSSCH transmission 315 based on both the first SCI 325 and the second SCI 330 being included in each LBT sub-band. For example, the first UE may determine whether to transmit the partial PSSCH transmission 315 based on the threshold quantity of LBT sub-bands having a successful LBT procedure (e.g., Y) as described with reference to FIG. 3A. For example, LBT sub-band 320-b-3 and LBT sub-band 320-b-2 may be associated with successful LBT procedures, while LBT sub-band 320-b-1 may be associated with an unsuccessful (e.g., failed) LBT procedure. If the quantity of LBT sub-bands 320 associated with successful LBT procedures satisfies the threshold quantity, the first UE may transmit the partial PSSCH transmission 315. For example, as shown if FIG. 3B, if the threshold quantity corresponds to a ratio of 1/2 (e.g., for every two LBT sub-bands, at least one LBT sub-band 320 may have a success LBT procedure), the UE may transmit the partial PSSCH transmission 315. (e.g., because in this example, ⅔ of the LBT sub-bands 320 in the carrier 310 passed an LBT procedure).

FIG. 3C illustrates an example of a wideband carrier diagram 300-c that supports mapping techniques for partial sidelink transmissions using wideband operations in accordance with one or more aspects of the present disclosure. In some examples, the wideband carrier diagram 300-c may implement aspects of the wireless communications system 100, the wireless communications system 200 and the wideband carrier diagrams 300-a and 300-b. For example, the wideband carrier diagram 300-c may be implemented at a UE as described with reference to FIGS. 1 and 2.

As described with reference to FIG. 3C the wireless communications system may support sidelink communication using a wideband carrier 310 that includes multiple LBT sub-bands 320 (e.g., LBT sub-band 320-c-1, LBT sub-band 320-c-2, and LBT sub-band 320-c-3). In some cases, as described with reference to FIG. 2, a PSSCH transmission may be mapped to the LBT sub-bands 320. For example, the LBT sub-bands 320 may be treated as a single band. In such examples, a first UE may perform multiple LBT procedures (e.g., respective LBT procedures for the multiple LBT sub-bands 320) to gain access to the channel for sidelink transmissions using the LBT sub-bands 320. For example, the first UE may perform a first LBT procedure associated with the LBT sub-band 320-c-1, a second LBT procedure for the LBT sub-band 320-c-2, and a third LBT procedure for LBT sub-band 320-c-3.

In some cases, a first SCI 325 and a second SCI 330 (as described with reference to FIGS. 3A and 3B) may be included (e.g., repeated) in each LBT sub-band 320. For example, SCI 325-c-1, SCI 325-c-2, and SCI 325-c-3 may be repetitions of the first SCI 325 while SCI 330-c-1, SCI 330-c-2, and SCI 330-c-3 may be repetitions of the second SCI 330. The first UE may determine whether to transmit a partial PSSCH transmission 315 based on both the first SCI 325 and the second SCI 330 being included in each LBT sub-band. For example, the first UE may determine whether to transmit the partial PSSCH transmission 315 based on the threshold quantity of LBT sub-bands having a successful LBT procedure as described with reference to FIG. 3A. For example, LBT sub-band 320-c-1 and LBT sub-band 320-c-2 may be associated with unsuccessful (e.g., failed) LBT procedures, while LBT sub-band 320-c-3 may be associated with a successful LBT procedure. If the quantity of LBT sub-bands 320 associated with successful LBT procedures does not satisfy the threshold quantity, the first UE may refrain from transmitting the partial PSSCH transmission 315. In some cases, the first UE may drop the PSSCH transmission altogether. For example, as shown if FIG. 3C, if the threshold quantity corresponds to a ratio of 1/2 (e.g., one successful LBT procedure for every two LBT sub-bands 320), the UE may refrain from transmitting the partial PSSCH transmission 315 (e.g., because in this example, only ⅓ of the LBT sub-bands 320 in the carrier 310 passed an LBT procedure).

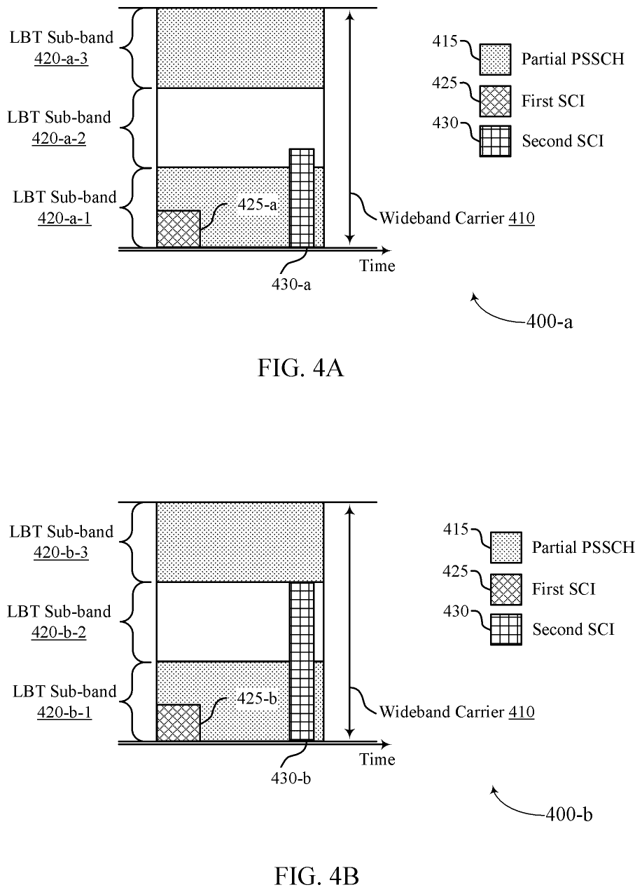

FIG. 4A illustrates an example of a wideband carrier diagram 400-a that supports mapping techniques for partial sidelink transmissions using wideband operations in accordance with one or more aspects of the present disclosure. In some examples, the wideband carrier diagram 400-a may implement aspects of the wireless communications system 100, the wireless communications system 200 and the wideband carrier diagrams 300. For example, the wideband carrier diagram 400-a may be implemented at a UE as described with reference to FIGS. 1 and 2.

A wireless communications system may support wideband operations for sidelink communications using the shared radio frequency spectrum band. For example, the wireless communications system may support sidelink communication using a wideband carrier 410 that includes multiple LBT sub-bands 420 (e.g., LBT sub-band 420-a-1, LBT sub-band 420-a-2, and LBT sub-band 420-a-3). In some cases, as described with reference to FIGS. 2 and 3A-3B, a PSSCH transmission may be mapped to the LBT sub-bands 420, and the first UE may perform a first LBT procedure associated with the LBT sub-band 420-a-1, a second LBT procedure for the LBT sub-band 420-a-2, and a third LBT procedure for LBT sub-band 420-a-3.

In some cases, the first UE may determine whether to transmit a partial PSSCH transmission 415 (e.g., a portion of the PSSCH transmission) via a subset of the LBT sub-bands 420 based on at least one LBT procedure of the respective LBT procedures failing. For example, the partial PSSCH transmission 415 may be associated with LBT sub-bands 420 corresponding to successful LBT procedures.

The PSSCH transmission may include a first SCI 425 (e.g., SCI 1) and a second SCI 430 (e.g., SCI 2). In some cases, a first SCI 425-a may be included in one LBT sub-band 420-a-1, which may be considered a primary band, and a second SCI 430-a may be a wideband mapping (e.g., included in more than one LBT sub-band 420). For example, SCI 430-a may be included (at least partially) in both LBT sub-band 420-a-1 and LBT sub-band 420-a-2. The first UE may determine whether to transmit the partial PSSCH 415 based on the first SCI 425-a being included in LBT sub-band 420-a-1 and SCI 430-a being included in two or more LBT sub-bands 420 (e.g., LBT sub-band 420-a-1 and LBT sub-band 420-a-2). For example, the first UE may transmit the partial PSSCH 415 via the subset of LBT sub-bands 420 associated with successful LBT procedures if LBT sub-band 420-a-1 (e.g., the primary sub-band carrying the first SCI 425-a) is included in the subset of sub-bands 420 and if a threshold percentage (e.g., X) of the second SCI 430-a is included in LBT sub-bands 420 having successful LBT procedures. For example, if LBT sub-band 420-a-2 has an unsuccessful LBT procedure, if the threshold percentage of SCI 430-a is included in LBT sub-band 420-a-1 with a successful LBT procedure, the first UE may transmit the partial PSSCH transmission 415. In some cases, the threshold percentage of SCI 430-a may be predefined, while in some cases the threshold percentage of SCI 430-a may be configured through radio resource control (RRC) signaling (e.g., form a network entity 105 as described with reference to FIG. 1).

In some cases, the first UE may transmit the partial PSSCH transmission 415 based on the quantity of LBT sub-bands 420 included in the subset of LBT sub-bands 420 (e.g., the LBT sub-bands 420 to be used to transmit the partial PSSCH transmission 415) satisfying a threshold quantity of LBT sub-bands having a successful LBT procedure. For example, the threshold quantity of LBT sub-bands may correspond to the partial PSSCH transmission 415 to be transmitted (e.g., over the LBT sub-bands 420 associated with a successful LBT procedure) over the entire PSSCH transmission. If the partial PSSCH transmission 415 to be transmitted satisfies (e.g., exceeds) the threshold, the first UE may transmit the partial PSSCH transmission 415, and if the partial PSSCH transmission 415 to be transmitted fails to satisfy (e.g., is below) the threshold, the first UE may drop the PSSCH transmission altogether.

FIG. 4B illustrates an example of a wideband carrier diagram 400-b that supports mapping techniques for partial sidelink transmissions using wideband operations in accordance with one or more aspects of the present disclosure. In some examples, the wideband carrier diagram 400-b may implement aspects of the wireless communications system 100, the wireless communications system 200 and the wideband carrier diagrams 300 and 400-a. For example, the wideband carrier diagram 400-b may be implemented at a UE as described with reference to FIGS. 1 and 2.

As described herein, a wireless communications system may support wideband operations for sidelink communications using the shared radio frequency spectrum band. For example, the wireless communications system may support sidelink communication using a wideband carrier 410 that includes multiple LBT sub-bands 420 (e.g., LBT sub-band 420-b-1, LBT sub-band 420-b-2, and LBT sub-band 420-b-3). In some cases, a PSSCH transmission may be mapped to the LBT sub-bands 420, and the first UE may perform a first LBT procedure associated with the LBT sub-band 420-b-1, a second LBT procedure for the LBT sub-band 420-b-2, and a third LBT procedure for LBT sub-band 420-b-3.

In some cases, the first UE may determine whether to transmit a partial PSSCH transmission 415 (e.g., a portion of the PSSCH transmission) via a subset of the LBT sub-bands 420 based on at least one LBT procedure of the respective LBT procedures failing. For example, the partial PSSCH transmission 415 may be associated with LBT sub-bands 420 corresponding to successful LBT procedures.

The PSSCH transmission may include a first SCI 425-b (e.g., SCI 1) and a second SCI 430-b (e.g., SCI 2). In some cases, the first SCI 425-b may be included in one LBT sub-band 420-b-1, which may be considered a primary band, and the second SCI 430-b may be a wideband mapping (e.g., included (at least partially) in more than one LBT sub-band 420). For example, SCI 430-b may be included in both LBT sub-band 420-b-1 and LBT sub-band 420-b-2. The first UE may determine whether to transmit the partial PSSCH 415 based on the first SCI 425-b being included in LBT sub-band 420-b-1 and SCI 430-b being included in two or more LBT sub-bands 420 (e.g., LBT sub-band 420-b-1 and LBT sub-band 420-b-2). For example, the first UE may refrain from transmitting the partial PSSCH 415 and may drop the PSSCH transmission altogether if a threshold percentage of the second SCI 430-a is included LBT sub-band 420-b-2 having an unsuccessful LBT procedure.

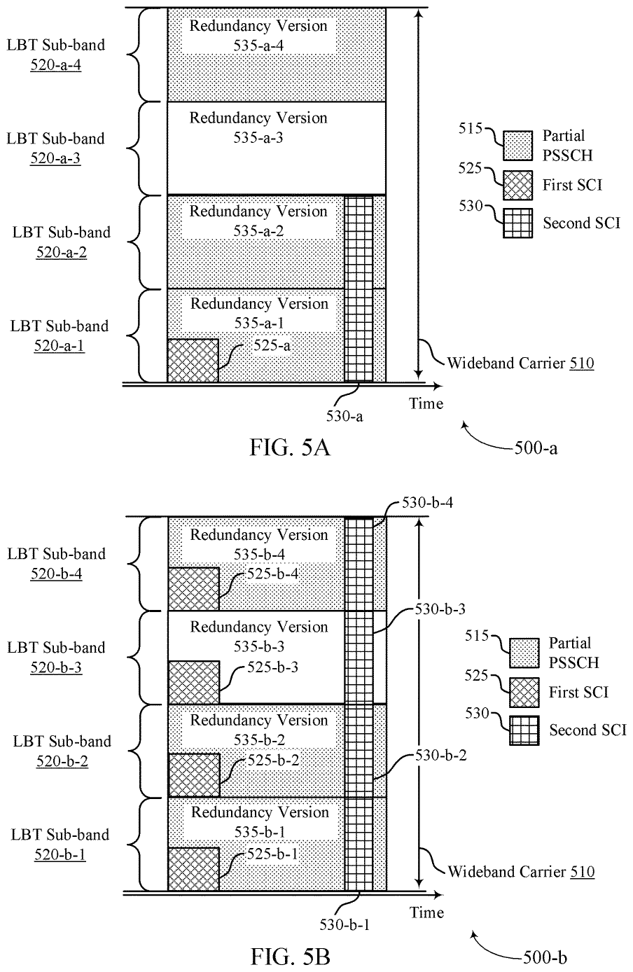

FIG. 5A illustrates an example of a wideband carrier diagram 500-a that supports mapping techniques for partial sidelink transmissions using wideband operations in accordance with one or more aspects of the present disclosure. In some examples, the wideband carrier diagram 500-a may implement aspects of the wireless communications system 100, the wireless communications system 200 and the wideband carrier diagrams 300 and 400. For example, the wideband carrier diagram 500-a may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier 510 that includes multiple LBT sub-bands 520 (e.g., LBT sub-band 520-a-1, LBT sub-band 520-a-2, LBT sub-band 520-a-3, and LBT sub-band 520-a-4). In some cases, a PSSCH transmission may be mapped to each of the LBT sub-bands 520, and the first UE may perform a first LBT procedure associated with the LBT sub-band 520-a-1, a second LBT procedure for the LBT sub-band 520-a-2, a third LBT procedure for LBT sub-band 520-a-3, and a fourth LBT procedure for LBT sub-band 520-a-4. For example, the first UE may map (e.g., generate) a different redundancy version 535 of a transport block associated with the PSSCH transmission to respective LBT sub-bands 520. For example, a redundancy version 535-a-1 may be mapped to LBT sub-band 520-a-1, a redundancy version 535-a-2 may be mapped to LBT sub-band 520-a-2, a redundancy version 535-a-3 may be mapped to LBT sub-band 520-a-3, and a redundancy version 535-a-4 may be mapped to LBT sub-band 520-a-4. In some cases, the different redundancy versions 535 may be mapped to the respective LBT sub-bands 520 based on a predefined mapping rule. The MCS associated with the PSSCH may ensure that the transport block may fit in one LBT sub-band.

In some cases, the first UE may determine whether to transmit a partial PSSCH transmission 515 (e.g., a portion of the PSSCH transmission) via a subset of the LBT sub-bands 520 based on at least one LBT procedure of the respective LBT procedures failing. For example, the partial PSSCH transmission 515 may be associated with one or more LBT sub-bands 520 corresponding to successful LBT procedures.

The PSSCH transmission may include a first SCI 525-a (e.g., SCI 1) and a second SCI 530-a (e.g., SCI 2). In some cases, the first SCI 525-a and the second SCI 530-a may be included in one LBT sub-band 520-a-1, which may be considered a primary band. In such cases, the first UE may transmit a partial PSSCH transmission 515 (e.g., a portion of the PSSCH transmission) via a subset of LBT sub-bands 520 if the LBT procedure associated with LBT sub-band 520-a-1 was successful. If the LBT procedure associated with LBT sub-band 520-a-1 is unsuccessful, the first UE may refrain from transmitting the partial PSSCH transmission 515 and may drop the PSSCH transmission altogether.

In some cases, the first SCI 525-a may be included in one LBT sub-band 520-a-1, which may be considered a primary band, and the second SCI 530-a may be a wideband mapping included in more than one LBT sub-band 520. For example, SCI 530-a may be included in both LBT sub-band 520-a-1 and LBT sub-band 520-a-2. The first UE may determine whether to transmit the partial PSSCH 515 based on the first SCI 525-a being included in LBT sub-band 520-a-1 and the second SCI 530-a being included in two or more LBT sub-bands 520 (e.g., LBT sub-band 520-a-1 and LBT sub-band 520-a-2). For example, the first UE may transmit the partial PSSCH 515 via the subset of LBT sub-bands 520 associated with successful LBT procedures if LBT sub-band 520-a-1 (e.g., the primary sub-band carrying the first SCI 425-a) is included in the subset of sub-bands 520 with successful LBT procedures and if a threshold percentage of the second SCI 530-a is included in LBT sub-bands 520 having successful LBT procedures. For example, if LBT sub-band 520-a-3 has an unsuccessful LBT procedure, if the threshold percentage of SCI 530-a is included in LBT sub-band 520-a-1 and LBT sub-band 520-a-2 with a successful LBT procedures, the first UE may transmit the partial PSSCH transmission 515. In another example, the first UE may refrain from transmitting the partial PSSCH transmission 515 and may drop the PSSCH transmission based on a threshold percentage of the second SCI 530-a (e.g., SCI 2) being included in a LBT sub-band 520 that failed the LBT procedure.

In some cases, the threshold percentage of SCI 530-a may be predefined, while in some cases the threshold percentage of SCI 530-a may additionally, or alternatively be configured via RRC signaling (e.g., form a network entity 105, as described with reference to FIG. 1).

FIG. 5B illustrates an example of a wideband carrier diagram 500-b that supports mapping techniques for partial sidelink transmissions using wideband operations in accordance with one or more aspects of the present disclosure. In some examples, the wideband carrier diagram 500-b may implement aspects of the wireless communications system 100, the wireless communications system 200 and the wideband carrier diagrams 300, 400, and 500-a. For example, the wideband carrier diagram 500-b may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier 510 that includes multiple LBT sub-bands 520 (e.g., LBT sub-band 520-b-1, LBT sub-band 520-b-2, LBT sub-band 520-b-3, and LBT sub-band 520-b-4).

In some cases, a PSSCH transmission may be mapped to each of the LBT sub-bands 520, and the first UE may perform a first LBT procedure associated with the LBT sub-band 520-b-1, a second LBT procedure for the LBT sub-band 520-b-2, a third LBT procedure for LBT sub-band 520-b-3, and a fourth LBT procedure for LBT sub-band 520-b-4. For example, the first UE may map (e.g., generate) a different redundancy version 535 of a transport block associated with the PSSCH transmission to respective LBT sub-bands 520. For example, a redundancy version 535-b-1 may be mapped to LBT sub-band 520-b-1, a redundancy version 535-b-2 may be mapped to LBT sub-band 520-b-2, a redundancy version 535-b-3 may be mapped to LBT sub-band 520-b-3, and a redundancy version 535-b-4 may be mapped to LBT sub-band 520-b-4. In some cases, the different redundancy versions 535 may be mapped to the respective LBT sub-bands 520 based on a predefined mapping rule. In some cases, a second SCI 530 (e.g., SCI 2) may indicate a redundancy version 535 corresponding to the respective LBT sub-band 520 that includes the second SCI 530. For example, each LBT sub-band 520 may include a respective second SCI 530 which may contain a field that indicates the redundancy version associated with the LBT sub-band 520. In some cases, a selection of the MCS associated with the PSSCH may ensure that the transport block may fit in one LBT sub-band.

In some cases, a first SCI 525 and a second SCI 530 may be included (e.g., repeated) in each LBT sub-band 520. The first UE may determine whether to transmit a partial PSSCH transmission 315 based on both the first SCI 525 and the second SCI 530 being included in each LBT sub-band. For example, the first UE may transmit the partial PSSCH transmission 515 via a subset of LBT sub-bands 520 (e.g., LBT sub-band 520-b-1, LBT sub-band 520-b-2, and LBT sub-band 520-b-4) associated with successful LBT procedures. In another example, the first you may drop the PSSCH transmission based on failed LBT procedures for the LBT sub-bands 520.

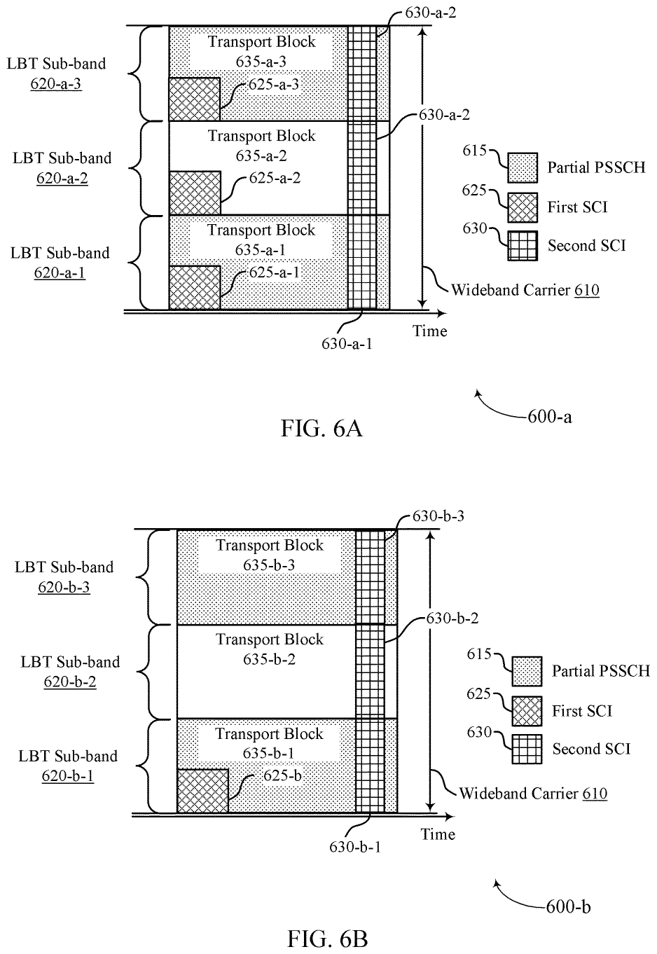

FIG. 6A illustrates an example of a wideband carrier diagram 600-a that supports mapping techniques for partial sidelink transmissions using wideband operations in accordance with one or more aspects of the present disclosure. In some examples, the wideband carrier diagram 600-a may implement aspects of the wireless communications system 100, the wireless communications system 200 and the wideband carrier diagrams 300, 400, and 500. For example, the wideband carrier diagram 600-a may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier 610 that includes multiple LBT sub-bands 620 (e.g., LBT sub-band 620-a-1, LBT sub-band 620-a-2, and LBT sub-band 620-a-3).

In some cases, a PSSCH transmission may be mapped to each of the LBT sub-bands 620, and the first UE may perform a first LBT procedure associated with the LBT sub-band 620-a-1, a second LBT procedure for the LBT sub-band 620-a-2, and a third LBT procedure for LBT sub-band 620-a-3. For example, the first UE may map a different transport block 635 associated with the PSSCH to each respective LBT sub-band 620. For example, a transport block 635-a-1 may be mapped to LBT sub-band 635-a-1, a transport block 635-a-2 may be mapped to LBT sub-band 635-a-2, and a transport block 635-a-3 may be mapped to LBT sub-band 635-a-3.

In some cases, a set of a first SCI 625 (e.g., SCI 1) and a second SCI 630 (SCI 2) associated with the PSSCH transmission may be included (e.g., repeated) in each LBT sub-band 620. Each set of the first SCI 625 and the second SCI 630 may indicate a respective transport block associated with the LBT sub-band 520. For example, the set of the first SCI 615-a-1 and the second SCI 615-a-2 may indicate that a transport block 635-a-1 is associated with LBT sub-band 620-a-1.

In some cases, the first UE may transmit a partial PSSCH transmission 615 based on the respective LBT procedures associated with each LBT sub-band 620. For example, if LBT sub-band 620-a-1 and LBT sub-band 620-a-3 have successful LBT procedures while LBT sub-band 620-b-2 has an unsuccessful LBT procedure, the first UE may transmit a partial PSSCH 615 using LBT sub-band 620-a-1 and LBT sub-band 620-a-3.

FIG. 6B illustrates an example of a wideband carrier diagram 600-b that supports mapping techniques for partial sidelink transmissions using wideband operations in accordance with one or more aspects of the present disclosure. In some examples, the wideband carrier diagram 600-b may implement aspects of the wireless communications system 100, the wireless communications system 200 and the wideband carrier diagrams 300-600-a. For example, the wideband carrier diagram 600-b may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier 610 that includes multiple LBT sub-bands 620 (e.g., LBT sub-band 620-b-1, LBT sub-band 620-b-2, and LBT sub-band 620-b-3).

In some cases, a PSSCH transmission may be mapped to each of the LBT sub-bands 620, and the first UE may perform a first LBT procedure associated with the LBT sub-band 620-b-1, a second LBT procedure for the LBT sub-band 620-b-2, and a third LBT procedure for LBT sub-band 620-b-3. For example, the first UE may map a different transport block 635 associated with the PSSCH to each respective LBT sub-band 620. For example, a transport block 635-b-1 may be mapped to LBT sub-band 635-b-1, a transport block 635-b-2 may be mapped to LBT sub-band 635-b-2, and a transport block 635-b-3 may be mapped to LBT sub-band 635-b-3.

In some cases, a first SCI 625-b (e.g., SCI 1) may be included in the LBT sub-band 620-b-1 and each LBT sub-band 620 may include a respective second SCI 630 (e.g., SCI 2) (e.g., a second SCI 630-b-1, a second SCI 630-b-2, and a second SCI 630-b-3). The first SCI 625-b may include an indication of an MCS and a resource allocation for the wideband carrier 610, and each of the second SCI 630 may indicate one or more information fields, such as a HARQ ID and/or a new data indicator (NDI), for the respective transport block 635. In some cases, the resource allocation may be based on a quantity of LBT sub-bands 620 of the plurality of LBT sub-bands 620, or a ratio of available frequency resources of the wideband carrier 610. In some cases, the second SCI 630 may indicate a resource allocation for each LBT sub-band 620. As an example, a resource allocation for the transport block 635 in each LBT sub-band 620 (e.g., as indicated by the first SCI 625-b) may be equal to a total quantity of resources divided by the quantity of LBT sub-bands 620 (e.g., a total quantity of resources divided by three sub-bands, where the resources may be split between three transport blocks 635). In another example, the resource allocation for each transport block 635 (e.g., as indicated by the first SCI 625-b) may be equal to a ratio of available frequency resources over a total set of available frequency resources. Additionally, or alternatively, the resource allocation for each transport block 635 may be explicitly indicated by the second SCI 630 (e.g., within each LBT sub-band 620).

In some cases, the first UE may transmit a partial PSSCH transmission 615 based on whether the first SCI 625-b may be transmitted. For example, if the LBT procedure associated with LBT sub-band 620-b-1 is successful, the first UE may transmit the partial PSSCH transmission 615, whereas if the LBT procedure associated with LBT sub-band 620-b-1 is unsuccessful, the first UE may drop the PSSCH transmission.

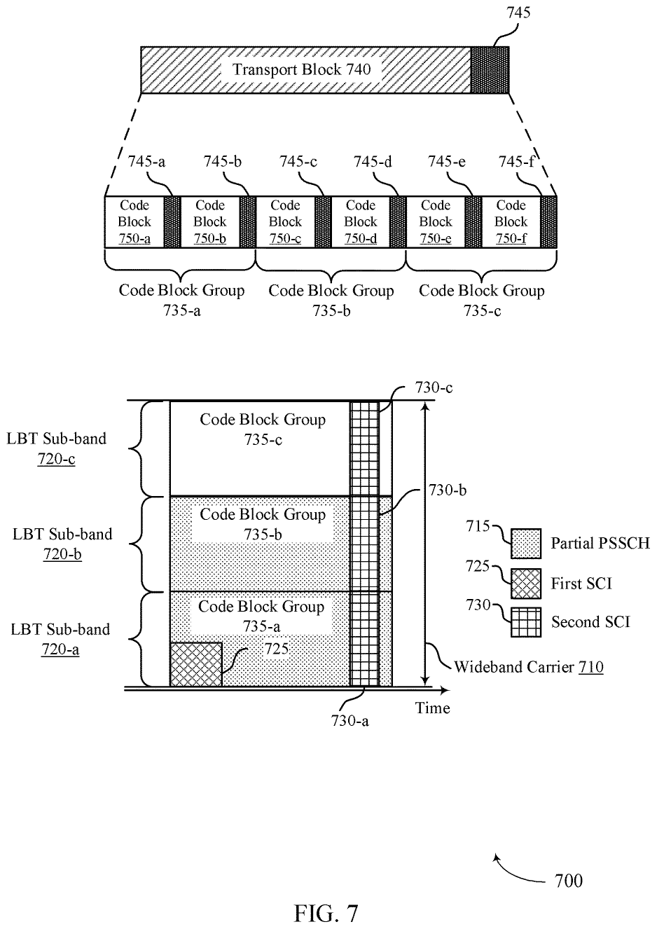

FIG. 7A illustrates an example of a wideband carrier diagram 700 that supports mapping techniques for partial sidelink transmissions using wideband operations in accordance with one or more aspects of the present disclosure. In some examples, the wideband carrier diagram 700 may implement aspects of the wireless communications system 100, the wireless communications system 200 and the wideband carrier diagrams 300-600. For example, the wideband carrier diagram 700 may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier 710 that includes multiple LBT sub-bands 720 (e.g., LBT sub-band 720-a, LBT sub-band 720-b, and LBT sub-band 720-c).

In some cases, a PSSCH transmission may be mapped to each of the LBT sub-bands 720, and the first UE may perform a first LBT procedure associated with the LBT sub-band 720-a, a second LBT procedure for the LBT sub-band 720-b, and a third LBT procedure for LBT sub-band 720-c. In some cases, the first UE may map respective sets of code block groups 735 of a transport block 740 associated with the PSSCH transmission to respective LBT sub-bands 720. For example, a transport block 740 and a cyclic redundancy check (CRC) 745 may be broken into code blocks 750-a through 750-f and CRCs 745-a through 745-f, which may then be grouped into code block group 735-a, code block group 735-b, and code block group 735-c, as shown in FIG. 7. The first UE may map each code block group 735 to a respective LBT sub-band 720. For example, code block group 735-a may be mapped to LBT sub-band 720-a, code block group 735-b may be mapped to LBT sub-band 720-b, and code block group 735-c may be mapped to LBT sub-band 720-c.

In some cases, a threshold quantity of code block groups 735 in each set of code block groups 735 (e.g., associated with the PSSCH transmission) may be based at least in part on an integer multiple of a quantity of LBT sub-bands 720. For example, the threshold quantity of code block groups 735 per transport block 740 may be equal to the quantity of LBT sub-bands 720. In some cases, if the quantity of code blocks 750 in the transport block 740 is less than the quantity of code block groups 735 (e.g., the quantity of LBT sub-bands 720), the code block group 735 based PSSCH transmission may be disabled. In some cases, the threshold quantity of code block groups 735 may be indicated through PC5-RRC signaling or in a first SCI 725.

In some cases, LBT sub-band 720-a may include the first SCI 725 (e.g., SCI 1) and may be considered a primary sub-band, and each LBT sub-band 720 may include a respective second SCI 730 (e.g., SCI 2) (e.g., SCI 730-a, SCI 730-b, SCI 730-c). In some cases, the first UE may transmit a partial PSSCH transmission 715 (e.g., a portion of the PSSCH transmission) via LBT sub-bands 720 having successful LBT procedures if the LBT procedure for LBT sub-band 720-a (e.g., the primary sub-band containing the first SCI 725) is successful.

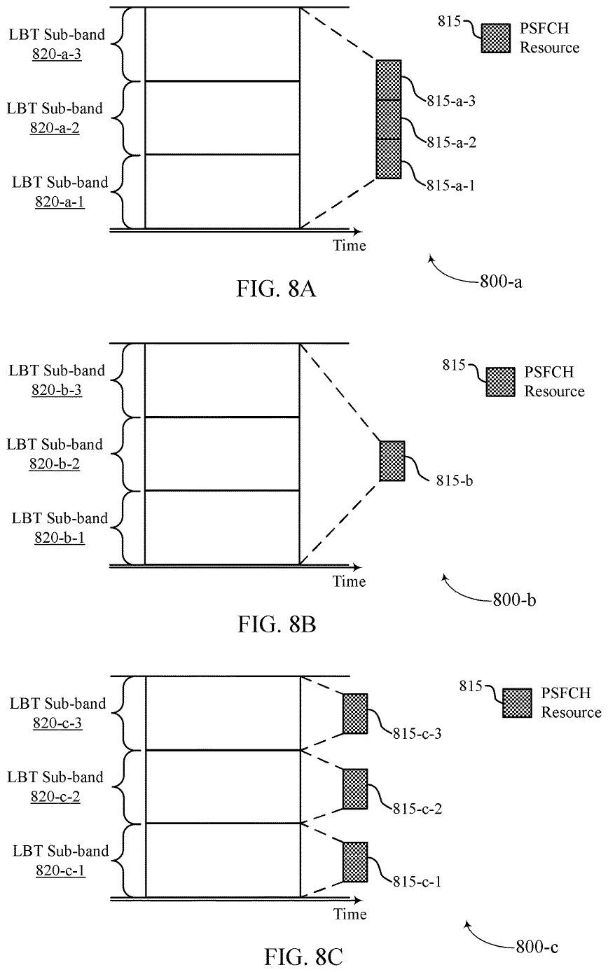

FIG. 8A illustrates an example of a wideband carrier diagram 800-a that supports mapping techniques for partial sidelink transmissions using wideband operations in accordance with one or more aspects of the present disclosure. In some examples, the wideband carrier diagram 800-a may implement aspects of the wireless communications system 100, the wireless communications system 200 and the wideband carrier diagrams 300-700. For example, the wideband carrier diagram 800-a may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier, as described with reference to FIGS. 2 through 7, that includes multiple LBT sub-bands 820 (e.g., LBT sub-band 820-a-1, LBT sub-band 820-a-2, and LBT sub-band 820-a-3).

In some cases, the first UE may transmit a partial PSSCH transmission based on a mapping between the PSSCH transmission and the LBT sub-bands 820, as described with reference to FIGS. 3 through 7. A second UE may receive the partial PSSCH transmission and may transmit feedback based on the partial PSSCH transmission. For example, the first UE may receive a feedback message via one or more physical sidelink feedback channels (PSFCHs) that indicates whether the PSSCH transmission was decoded by the second UE.

In some cases, the feedback message may include a single bit to indicate whether the PSSCH transmission was decoded based on the mapping of the PSSCH transmission. For example, if the mapping is based on mapping multiple transport blocks of the PSSCH to LBT sub-bands 820, as described with reference to FIGS. 6A and 6B, or based on code block groups, as described with reference to FIG. 7, if there is at least one negative acknowledgment (NACK) the second UE may indicate NACK with the single bit. In another example, if the mapping is based on multiple redundancy versions of a transport block, as described with reference to FIG. 5, if there is at least one ACK, the second UE may indicate ACK with the single bit.

In some cases, the feedback message may include multiple bits to indicate whether the PSSCH transmission was decoded based on the mapping of the PSSCH transmission. For example, if the mapping is based on mapping multiple transport blocks of the PSSCH to LBT sub-bands 820, as described with reference to FIGS. 6A and 6B, or based on code block groups, as described with reference to FIG. 7, the second UE may a separate bit to indicate ACK or NACK for each LBT sub-band 820 for the PSSCH transmission. In some cases, the multiple bits may be included in a single PSFCH. In some cases, each bit of the multiple bits may be included in a respective PSFCH.

In some cases, the first UE may receive the feedback message via a set of PSSCH resources 815 that are from a resource pool that is based on the wideband operations. For example, the second UE may map a PSFCH resource 815-a-1, a PSFCH resource 815-a-2, and a PSFCH resource 815-a-3 to the wideband carrier (e.g., including the LBT sub-bands 820) as a whole. In some cases, if multiple bits are used to indicate the PSSCH reception, the quantity of PSFCH resources may be equal to the quantity LBT sub-bands 820.

FIG. 8B illustrates an example of a wideband carrier diagram 800-b that supports mapping techniques for partial sidelink transmissions using wideband operations in accordance with one or more aspects of the present disclosure. In some examples, the wideband carrier diagram 800-b may implement aspects of the wireless communications system 100, the wireless communications system 200 and the wideband carrier diagrams 300 through 800-a. For example, the wideband carrier diagram 800-b may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier, as described with reference to FIGS. 2 through 7, that includes multiple LBT sub-bands 820 (e.g., LBT sub-band 820-b-1, LBT sub-band 820-b-2, and LBT sub-band 820-b-3).

In some cases, the first UE may transmit a partial PSSCH transmission based on a mapping between the PSSCH transmission and the LBT sub-bands 820, as described with reference to FIGS. 3 through 7. A second UE may receive the partial PSSCH transmission and may transmit feedback based on the partial PSSCH transmission. For example, the first UE may receive a feedback message via one or more physical sidelink feedback channels (PSFCHs) that indicates whether the PSSCH transmission was received and decoded by the second UE.

In some cases, as described with reference to FIG. 8A, the feedback message may include a single bit to indicate whether the PSSCH transmission was decoded based on the mapping of the PSSCH transmission. In such cases, the second UE may use one resource block (RB) for the PSFCH transmission.

In some cases, the first UE may receive the feedback message via a set of PSSCH resources 815 that are from a resource pool that is based on the wideband operations. For example, the second UE may map a PSFCH resource 815-b to the wideband carrier (e.g., including the LBT sub-bands 820) as a whole.

FIG. 8C illustrates an example of a wideband carrier diagram 800-c that supports mapping techniques for partial sidelink transmissions using wideband operations in accordance with one or more aspects of the present disclosure. In some examples, the wideband carrier diagram 800-c may implement aspects of the wireless communications system 100, the wireless communications system 200 and the wideband carrier diagrams 300-800-b. For example, the wideband carrier diagram 800-c may be implemented at a UE as described with reference to FIGS. 1 and 2.

As describe herein, a wireless communications system may support wideband operations for sidelink communications using the shared radio frequency spectrum band. For example, the wireless communications system may support sidelink communication using a wideband carrier, as described with reference to FIGS. 2 through 7, that includes multiple LBT sub-bands 820 (e.g., LBT sub-band 820-c-1, LBT sub-band 820-c-2, and LBT sub-band 820-c-3).

In some cases, the first UE may transmit a partial PSSCH transmission based on a mapping between the PSSCH transmission and the LBT sub-bands 820, as described with reference to FIGS. 3 through 7. A second UE may receive the partial PSSCH transmission and may transmit feedback based on the partial PSSCH transmission. For example, the first UE may receive a feedback message via one or more physical sidelink feedback channels (PSFCHs) that indicates whether the PSSCH transmission was decoded by the second UE.

In some cases, the feedback message may include a single bit to indicate whether the PSSCH transmission was decoded based on the mapping of the PSSCH transmission. In some cases, the feedback message may include multiple bits to indicate whether the PSSCH transmission was decoded based on the mapping of the PSSCH transmission.

In some cases, the first UE may receive the feedback message via a respective set of PSFCH resources 815 that are from different resource pools corresponding to the respective LBT sub-bands 820. For example, PSFCH resource 815-c-1 may correspond to LBT sub-band 820-c-1, PSFCH resource 815-c-2 may correspond to LBT sub-band 820-c-2, and PSFCH resource 815-c-3 may correspond to LBT sub-band 820-c-3. In some cases, such as if a single bit is used to indicate the PSSCH reception, the PSFCH may be repeated in each PSFCH resource 815. In some cases, such as if multiple bits are used to indicate the PSSCH reception, each bit may be included on a separate PSFCH resource 815. For example, a bit included on PSFCH resource 815-c-1 may correspond to whether LBT sub-band 820-c-1 was received successfully.

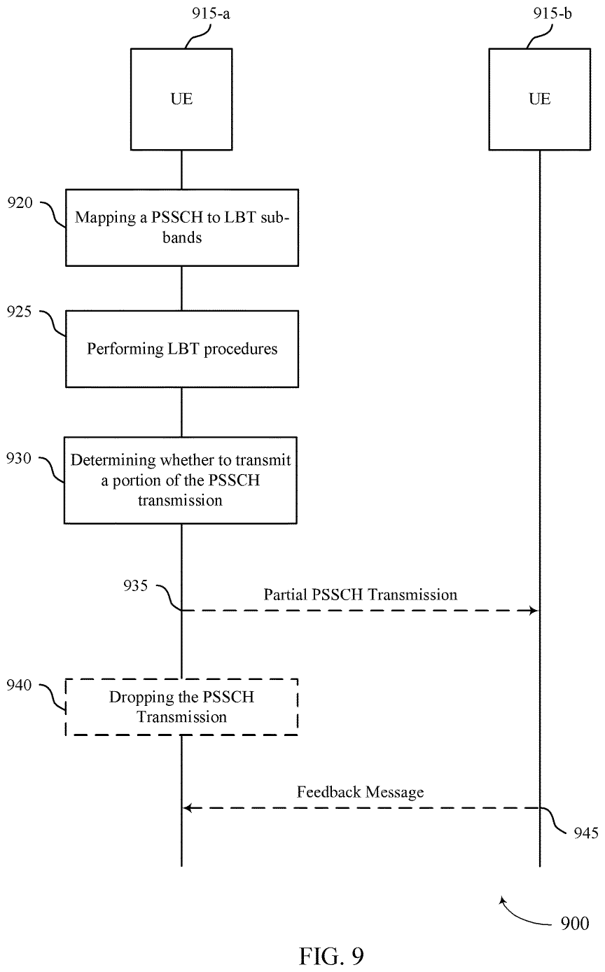

FIG. 9 illustrates an example of a process flow 900 in a system that supports mapping techniques for partial sidelink transmissions using wideband operations in accordance with one or more aspects of the present disclosure. The process flow 900 may implement or be implemented at or using one or more aspects of the wireless communications system 100, the wireless communications system 200, or the wideband carrier diagrams 300 through 800. For example, the process flow 900 may be implemented by a UE 915-a or a UE 915-b, which may be examples of the corresponding devices described with reference to FIGS. 1-8. In some examples, the UEs 915 may implement the process flow 900 to promote network efficiencies by supporting a framework for partial sidelink transmissions using a wideband carrier. The process flow 900 may also be implemented by the UEs 915 to promote high reliability and low latency operations, among other benefits. In the following description of the process flow 900, the operations between the UEs 915 may occur in a different order than the example order shown, or the operations performed by the UEs 915 may be performed in different orders or at different times. Some operations may also be omitted or added.

At 920, the UE 915-a may map a PSSCH to LBT sub-bands, as described with reference to FIGS. 2 through 7. For example, the UE 915-a may map the PSSCH to the LBT sub-bands as described with reference to FIGS. 3A, 3B, 3C, 4A, and 4B, or the UE 915-a may map the PSSCH to each of the LBT sub-bands as described with reference to FIGS. 5A, 5B, 6A, 6B, and 7. That is, the PSSCH may be mapped to a wideband carrier including multiple LBT sub-bands, which may result in various rules that define when the UE may transmit a partial PSSCH transmission to another UE using shared radio frequency spectrum, or the PSSCH may be mapped to respective LBT sub-bands of the wideband carrier.

At 925, the UE 915-a may perform LBT procedures. For example, the UE 915-a may perform a respective LBT procedure for each LBT sub-band to determine whether each LBT sub-band is available for transmission. As an example, the UE 915-a may sense each LBT sub-band to determine whether one or more other devices are transmitting on respective set of resources associated with the LBT sub-bands.

At 930, the UE 915-a may determine whether to transmit a portion of the PSSCH (e.g., a partial PSSCH). For example, the UE 915-a may determine whether to transmit the partial PSSCH based on the mapping of the LBT sub-bands and the result of the LBT procedures. In some aspects, the determination of whether to transmit the portion of the PSSCH may be based on the mapping of the PSSCH to the wideband carrier and one or more rules that define when the partial PSSCH may be transmitted.

In some cases, at 935, the UE 915-a may transmit, and the UE 915-b may receive, the PSSCH transmission, which may be the partial PSSCH transmission. In other cases, at 940, the UE 915-a may drop the PSSCH transmission altogether.

In some cases, at 945, the UE 915-b may transmit, and the UE 915-a may receive, a feedback message based on the partial PSSCH transmission, as described with reference to FIGS. 8A, 8B, and 8C. In some cases, the feedback message may include HARQ ACK/NACK which may be indicated via a single bit or using multiple bits. In some aspects, the resources used for carrying the feedback message may be based on the carrier used for wideband operation or based on LBT sub-bands. That is, a PSFCH resource pool may be based on wideband operation or the PSFCH resource pool may be based on respective LBT sub-bands.

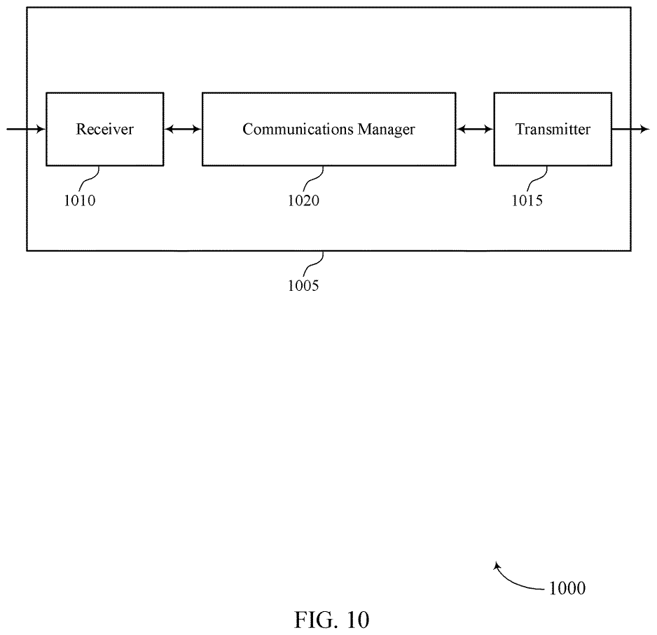

FIG. 10 shows a block diagram 1000 of a device 1005 that supports mapping techniques for partial sidelink transmissions using wideband operations in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to mapping techniques for partial sidelink transmissions using wideband operations). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to mapping techniques for partial sidelink transmissions using wideband operations). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of mapping techniques for partial sidelink transmissions using wideband operations as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples as disclosed herein. For example, the communications manager 1020 may be configured as or otherwise support a means for mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The communications manager 1020 may be configured as or otherwise support a means for performing respective LBT procedures for the set of multiple LBT sub-bands. The communications manager 1020 may be configured as or otherwise support a means for determining whether to transmit a portion of the PSSCH transmission via a subset of LBT sub-bands of the set of multiple LBT sub-bands based on at least one LBT procedure of the respective LBT procedures failing.

Additionally, or alternatively, the communications manager 1020 may support wireless communication in accordance with examples as disclosed herein. For example, the communications manager 1020 may be configured as or otherwise support a means for mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth. The communications manager 1020 may be configured as or otherwise support a means for performing respective LBT procedures for the set of multiple LBT sub-bands. The communications manager 1020 may be configured as or otherwise support a means for determining whether to transmit a portion of the PSSCH transmission via a subset of LBT sub-bands of the set of multiple LBT sub-bands based on at least one LBT procedure of the respective LBT procedures failing.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources.

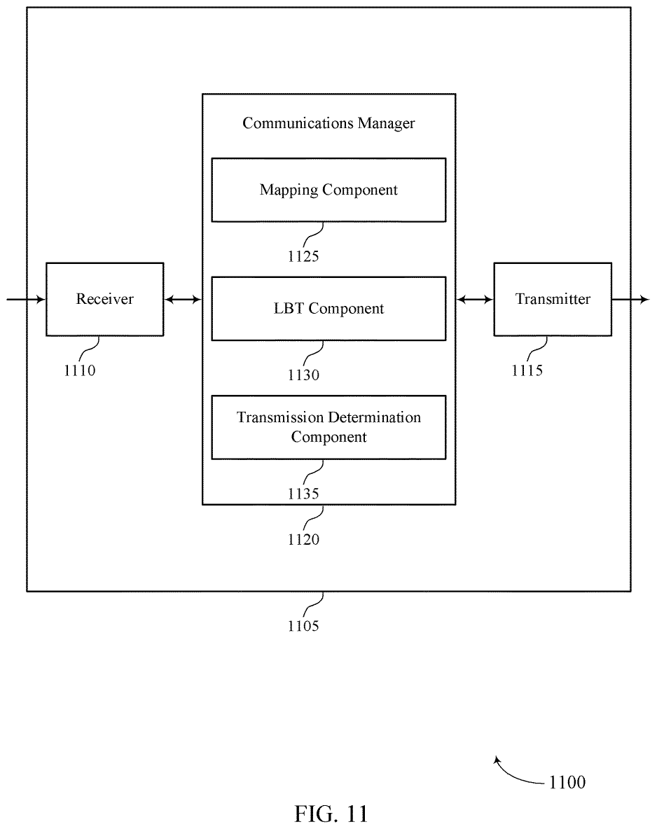

FIG. 11 shows a block diagram 1100 of a device 1105 that supports mapping techniques for partial sidelink transmissions using wideband operations in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to mapping techniques for partial sidelink transmissions using wideband operations). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to mapping techniques for partial sidelink transmissions using wideband operations). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of mapping techniques for partial sidelink transmissions using wideband operations as described herein. For example, the communications manager 1120 may include a mapping component 1125, an LBT component 1130, a transmission determination component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE in accordance with examples as disclosed herein. The mapping component 1125 may be configured as or otherwise support a means for mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The LBT component 1130 may be configured as or otherwise support a means for performing respective LBT procedures for the set of multiple LBT sub-bands. The transmission determination component 1135 may be configured as or otherwise support a means for determining whether to transmit a portion of the PSSCH transmission via a subset of LBT sub-bands of the set of multiple LBT sub-bands based on at least one LBT procedure of the respective LBT procedures failing.

Additionally, or alternatively, the communications manager 1120 may support wireless communication in accordance with examples as disclosed herein. The mapping component 1125 may be configured as or otherwise support a means for mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth. The LBT component 1130 may be configured as or otherwise support a means for performing respective LBT procedures for the set of multiple LBT sub-bands. The transmission determination component 1135 may be configured as or otherwise support a means for determining whether to transmit a portion of the PSSCH transmission via a subset of LBT sub-bands of the set of multiple LBT sub-bands based on at least one LBT procedure of the respective LBT procedures failing.

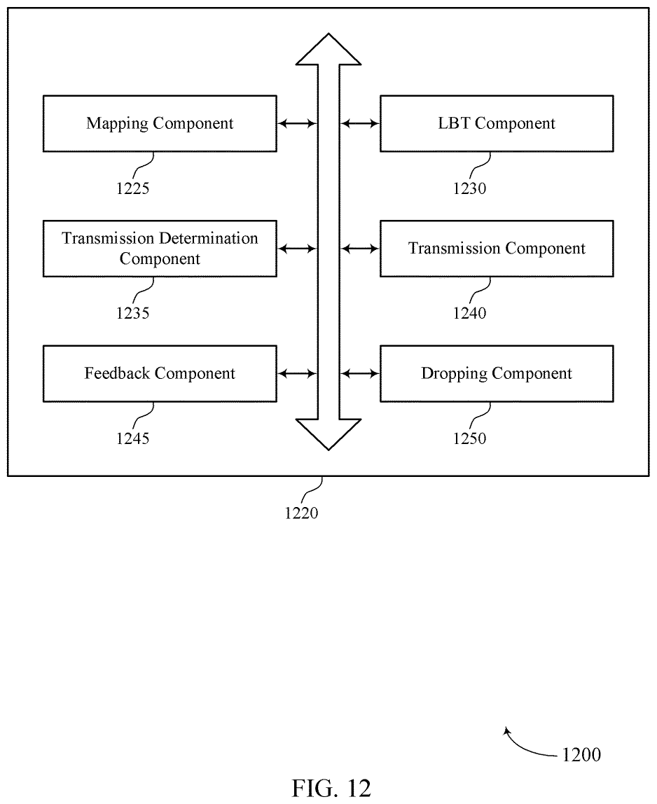

FIG. 12 shows a block diagram 1200 of a communications manager 1220 that supports mapping techniques for partial sidelink transmissions using wideband operations in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of mapping techniques for partial sidelink transmissions using wideband operations as described herein. For example, the communications manager 1220 may include a mapping component 1225, an LBT component 1230, a transmission determination component 1235, a transmission component 1240, a feedback component 1245, a dropping component 1250, or any combination thereof. Each of these components may communicate, directly or indirectly, with one another (e.g., via one or more buses).

The communications manager 1220 may support wireless communication at a UE in accordance with examples as disclosed herein. The mapping component 1225 may be configured as or otherwise support a means for mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The LBT component 1230 may be configured as or otherwise support a means for performing respective LBT procedures for the set of multiple LBT sub-bands. The transmission determination component 1235 may be configured as or otherwise support a means for determining whether to transmit a portion of the PSSCH transmission via a subset of LBT sub-bands of the set of multiple LBT sub-bands based on at least one LBT procedure of the respective LBT procedures failing.

In some examples, to support determining whether to transmit the portion of the PSSCH transmission, the transmission determination component 1235 may be configured as or otherwise support a means for determining whether to transmit the portion of the PSSCH transmission based on first sidelink control information and second sidelink control information associated with the PSSCH transmission both being included in a first LBT sub-band of the set of multiple LBT sub-bands.

In some examples, the transmission component 1240 may be configured as or otherwise support a means for transmitting the portion of the PSSCH transmission via the subset of LBT sub-bands, the subset of LBT sub-bands including the first LBT sub-band, where the portion of the PSSCH transmission is transmitted based on successful LBT procedures for each LBT sub-band of the subset of LBT sub-bands, and where the at least one LBT procedure that failed corresponds to one or more LBT sub-bands that are different from LBT sub-bands of the subset of LBT sub-bands.

In some examples, the portion of the PSSCH transmission is transmitted based on a quantity of LBT sub-bands of the subset of LBT sub-bands satisfying a threshold quantity of LBT sub-bands having a successful LBT procedure.

In some examples, the dropping component 1250 may be configured as or otherwise support a means for dropping the PSSCH transmission based on the first LBT sub-band corresponding to the at least one LBT procedure that failed.

In some examples, to support determining whether to transmit the portion of the PSSCH transmission, the transmission determination component 1235 may be configured as or otherwise support a means for determining whether to transmit the portion of the PSSCH transmission based on first sidelink control information and second sidelink control information associated with the PSSCH transmission being included in each LBT sub-band of the set of multiple LBT sub-bands.

In some examples, the transmission component 1240 may be configured as or otherwise support a means for transmitting the portion of the PSSCH transmission via the subset of LBT sub-bands based on a first quantity of LBT sub-bands of the subset of LBT sub-bands satisfying a threshold quantity of LBT sub-bands having a successful LBT procedure.

In some examples, the dropping component 1250 may be configured as or otherwise support a means for dropping the PSSCH transmission based on a second quantity of LBT sub-bands of the set of multiple LBT sub-bands failing to satisfy a threshold quantity of LBT sub-bands having a successful LBT procedure.

In some examples, to support determining whether to transmit the portion of the PSSCH transmission, the transmission determination component 1235 may be configured as or otherwise support a means for determining whether to transmit the portion of the PSSCH transmission based on first sidelink control information associated with the PSSCH transmission being included in a first LBT sub-band of the set of multiple LBT sub-bands and second sidelink control information associated with the PSSCH transmission being included in two or more LBT sub-bands of the set of multiple LBT sub-bands.

In some examples, the transmission component 1240 may be configured as or otherwise support a means for transmitting the portion of the PSSCH transmission via the subset of LBT sub-bands, the subset of LBT sub-bands including the first LBT sub-band, where the portion of the PSSCH transmission is transmitted based on successful LBT procedures for each LBT sub-band of the subset of LBT sub-bands and a threshold percentage of the second sidelink control information being included in LBT sub-bands having the successful LBT procedures.

In some examples, the portion of the PSSCH transmission is transmitted based on a quantity of LBT sub-bands of the subset of LBT sub-bands satisfying a threshold quantity of LBT sub-bands having a successful LBT procedure.

In some examples, the dropping component 1250 may be configured as or otherwise support a means for dropping the PSSCH transmission based on a threshold percentage of the second sidelink control information being included in the at least one LBT sub-band that failed the LBT procedure.

In some examples, to support mapping the PSSCH transmission, the mapping component 1225 may be configured as or otherwise support a means for mapping the PSSCH transmission across the set of multiple LBT sub-bands of the carrier, where the PSSCH transmission is mapped based on a frequency index of the carrier followed by a time index of the carrier.

Additionally, or alternatively, the communications manager 1220 may support wireless communication in accordance with examples as disclosed herein. In some examples, the mapping component 1225 may be configured as or otherwise support a means for mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth. In some examples, the LBT component 1230 may be configured as or otherwise support a means for performing respective LBT procedures for the set of multiple LBT sub-bands. In some examples, the transmission determination component 1235 may be configured as or otherwise support a means for determining whether to transmit a portion of the PSSCH transmission via a subset of LBT sub-bands of the set of multiple LBT sub-bands based on at least one LBT procedure of the respective LBT procedures failing.

In some examples, to support mapping the PSSCH transmission, the mapping component 1225 may be configured as or otherwise support a means for mapping a different redundancy version of a transport block associated with the PSSCH transmission to respective LBT sub-bands of the set of multiple LBT sub-bands, where the mapping is based on a modulation and coding scheme for the PSSCH transmission.

In some examples, to support determining whether to transmit the portion of the PSSCH transmission, the transmission determination component 1235 may be configured as or otherwise support a means for determining whether to transmit the portion of the PSSCH transmission based on first sidelink control information and second sidelink control information associated with the PSSCH transmission both being included in a first LBT sub-band of the set of multiple LBT sub-bands.

In some examples, the transmission component 1240 may be configured as or otherwise support a means for transmitting the portion of the PSSCH transmission via the subset of LBT sub-bands, the subset of LBT sub-bands including the first LBT sub-band, where the portion of the PSSCH transmission is transmitted based on successful LBT procedures for each LBT sub-band of the subset of LBT sub-bands, and where the at least one LBT procedure that failed corresponds to one or more LBT sub-bands that are different from LBT sub-bands of the subset of LBT sub-bands.

In some examples, the dropping component 1250 may be configured as or otherwise support a means for dropping the PSSCH transmission based on the first LBT sub-band corresponding to the at least one LBT procedure that failed.

In some examples, to support determining whether to transmit the portion of the PSSCH transmission, the transmission determination component 1235 may be configured as or otherwise support a means for determining whether to transmit the portion of the PSSCH transmission based on first sidelink control information associated with the PSSCH transmission being included in a first LBT sub-band of the set of multiple LBT sub-bands and second sidelink control information associated with the PSSCH transmission being included in two or more LBT sub-bands of the set of multiple LBT sub-bands.

In some examples, the transmission component 1240 may be configured as or otherwise support a means for transmitting the portion of the PSSCH transmission via the subset of LBT sub-bands, the subset of LBT sub-bands including the first LBT sub-band, where the portion of the PSSCH transmission is transmitted based on successful LBT procedures for each LBT sub-band of the subset of LBT sub-bands and a threshold percentage of the second sidelink control information being included in LBT sub-bands having the successful LBT procedures.

In some examples, the dropping component 1250 may be configured as or otherwise support a means for dropping the PSSCH transmission based on a threshold percentage of the second sidelink control information being included in the at least one LBT sub-band that failed the LBT procedure.

In some examples, to support determining whether to transmit the portion of the PSSCH transmission, the transmission determination component 1235 may be configured as or otherwise support a means for determining whether to transmit the portion of the PSSCH transmission based on first sidelink control information and second sidelink control information associated with the PSSCH transmission being included in each LBT sub-band of the set of multiple LBT sub-bands.

In some examples, the transmission component 1240 may be configured as or otherwise support a means for transmitting the portion of the PSSCH transmission via the subset of LBT sub-bands based on successful LBT procedures for LBT sub-bands of the subset of LBT sub-bands.

In some examples, the dropping component 1250 may be configured as or otherwise support a means for dropping the PSSCH transmission based on failed LBT procedures for LBT sub-bands of the set of multiple LBT sub-bands.

In some examples, the different redundancy versions of the transport block are mapped to the respective LBT sub-bands based on a predefined mapping rule.

In some examples, the transmission component 1240 may be configured as or otherwise support a means for transmitting, in each LBT sub-band of the set of multiple LBT sub-bands, first sidelink control information and second sidelink control information associated with the PSSCH transmission, the second sidelink control information indicating a redundancy version corresponding to the respective LBT sub-band that includes the second sidelink control information.

In some examples, to support mapping the PSSCH transmission, the mapping component 1225 may be configured as or otherwise support a means for mapping a different transport block associated with the PSSCH transmission to respective LBT sub-bands of the set of multiple LBT sub-bands.

In some examples, each LBT sub-band of the set of multiple LBT sub-bands includes a respective set of first sidelink control information and second sidelink control information associated with the PSSCH transmission. In some examples, each set of first sidelink control information and second sidelink control information indicates a respective transport block associated with an LBT sub-band.

In some examples, a first LBT sub-band of the set of multiple LBT sub-bands includes first sidelink control information and each LBT sub-band of the set of multiple LBT sub-bands includes a respective second sidelink control information, the first sidelink control information indicating a modulation and coding scheme and a resource allocation for the carrier, and each second sidelink control information indicating one or more information fields for a respective transport block of the one or more transport blocks.

In some examples, the resource allocation is based on a quantity of LBT sub-bands of the set of multiple sub-bands or a ratio of available frequency resources of the carrier.

In some examples, the second sidelink control information indicates a resource allocation for each LBT sub-band of the set of multiple LBT sub-bands.

In some examples, to support mapping the PSSCH transmission, the mapping component 1225 may be configured as or otherwise support a means for mapping a respective sets of code block groups of a transport block associated with the PSSCH transmission to respective LBT sub-bands of the set of multiple LBT sub-bands.

In some examples, a first LBT sub-band of the set of multiple LBT sub-bands includes first sidelink control information and each LBT sub-band of the set of multiple LBT sub-bands includes a respective second sidelink control information, and the transmission component 1240 may be configured as or otherwise support a means for transmitting the portion of the PSSCH transmission via the subset of LBT sub-bands based on successful LBT procedures for the first LBT sub-band, the subset of LBT sub-bands including the first LBT sub-band.

In some examples, a threshold quantity of code block groups in each set of code block groups is based on an integer multiple of a quantity of LBT sub-bands of the set of multiple LBT sub-bands.

In some examples, the transmission component 1240 may be configured as or otherwise support a means for transmitting at least the portion of the PSSCH transmission. In some examples, the feedback component 1245 may be configured as or otherwise support a means for receiving, via one or more physical sidelink feedback channels, a feedback message that indicates whether the PSSCH transmission was decoded by another UE, where the feedback message includes a single bit or multiple bits to indicate whether the PSSCH transmission was decoded based on the mapping of the PSSCH transmission.

In some examples, the feedback message includes the multiple bits. In some examples, the multiple bits are included in a single physical sidelink feedback channel.

In some examples, the feedback message includes the multiple bits. In some examples, each bit of the multiple bits is included in a respective physical sidelink feedback channel.

In some examples, to support receiving the feedback message, the feedback component 1245 may be configured as or otherwise support a means for receiving the feedback message via a set of physical sidelink feedback channel resources that are from a resource pool that is based on the wideband operations.

In some examples, to support receiving the feedback message, the feedback component 1245 may be configured as or otherwise support a means for receiving the feedback message via a respective sets of physical sidelink feedback channel resources that are from different resource pools corresponding to the respective LBT sub-bands of the set of multiple LBT sub-bands.

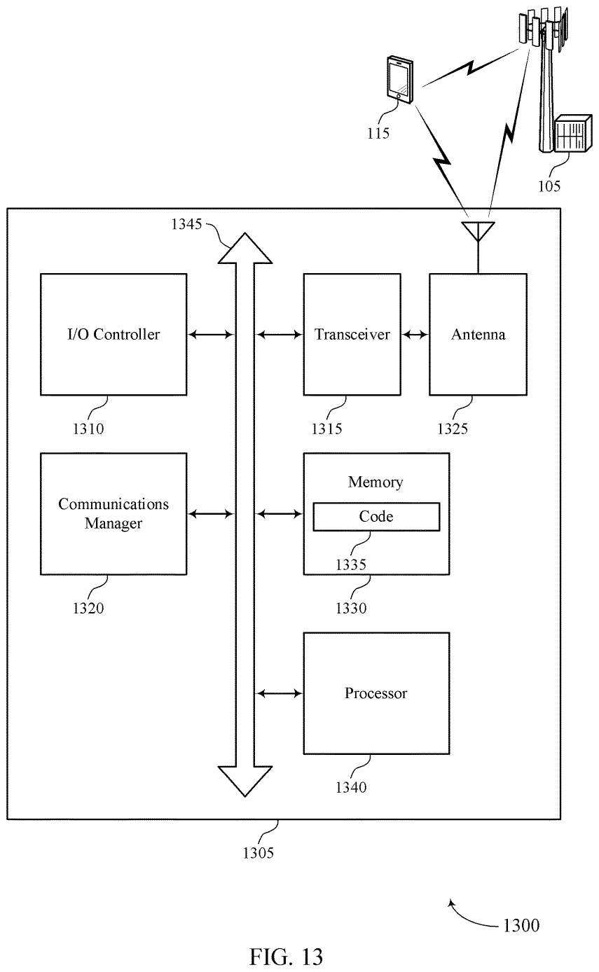

FIG. 13 shows a diagram of a system 1300 including a device 1305 that supports mapping techniques for partial sidelink transmissions using wideband operations in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting mapping techniques for partial sidelink transmissions using wideband operations). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication at a UE in accordance with examples as disclosed herein. For example, the communications manager 1320 may be configured as or otherwise support a means for mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The communications manager 1320 may be configured as or otherwise support a means for performing respective LBT procedures for the set of multiple LBT sub-bands. The communications manager 1320 may be configured as or otherwise support a means for determining whether to transmit a portion of the PSSCH transmission via a subset of LBT sub-bands of the set of multiple LBT sub-bands based on at least one LBT procedure of the respective LBT procedures failing.

Additionally, or alternatively, the communications manager 1320 may support wireless communication in accordance with examples as disclosed herein. For example, the communications manager 1320 may be configured as or otherwise support a means for mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth. The communications manager 1320 may be configured as or otherwise support a means for performing respective LBT procedures for the set of multiple LBT sub-bands. The communications manager 1320 may be configured as or otherwise support a means for determining whether to transmit a portion of the PSSCH transmission via a subset of LBT sub-bands of the set of multiple LBT sub-bands based on at least one LBT procedure of the respective LBT procedures failing.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of mapping techniques for partial sidelink transmissions using wideband operations as described herein, or the processor 1340 and the memory 1330 may be otherwise configured to perform or support such operations.

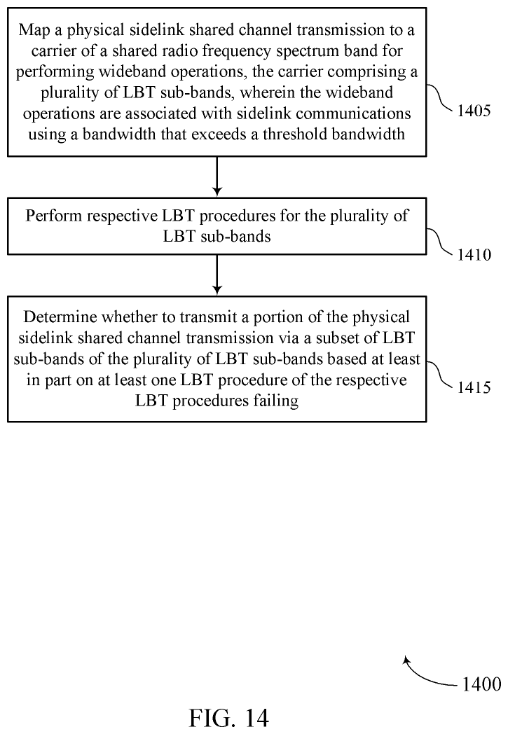

FIG. 14 shows a flowchart illustrating a method 1400 that supports mapping techniques for partial sidelink transmissions using wideband operations in accordance with one or more aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The operations of 1405 may be performed in accordance with examples as disclosed herein. In some examples, aspects of the operations of 1405 may be performed by a mapping component 1225 as described with reference to FIG. 12.

At 1410, the method may include performing respective LBT procedures for the set of multiple LBT sub-bands. The operations of 1410 may be performed in accordance with examples as disclosed herein. In some examples, aspects of the operations of 1410 may be performed by an LBT component 1230 as described with reference to FIG. 12.

At 1415, the method may include determining whether to transmit a portion of the PSSCH transmission via a subset of LBT sub-bands of the set of multiple LBT sub-bands based on at least one LBT procedure of the respective LBT procedures failing. The operations of 1415 may be performed in accordance with examples as disclosed herein. In some examples, aspects of the operations of 1415 may be performed by a transmission determination component 1235 as described with reference to FIG. 12.

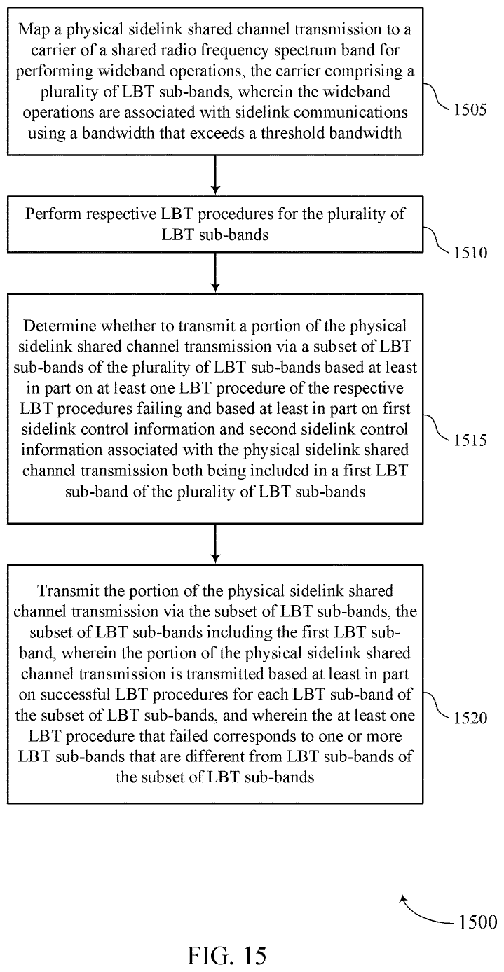

FIG. 15 shows a flowchart illustrating a method 1500 that supports mapping techniques for partial sidelink transmissions using wideband operations in accordance with one or more aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1505, the method may include mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The operations of 1505 may be performed in accordance with examples as disclosed herein. In some examples, aspects of the operations of 1505 may be performed by a mapping component 1225 as described with reference to FIG. 12.

At 1510, the method may include performing respective LBT procedures for the set of multiple LBT sub-bands. The operations of 1510 may be performed in accordance with examples as disclosed herein. In some examples, aspects of the operations of 1510 may be performed by an LBT component 1230 as described with reference to FIG. 12.

At 1515, the method may include determining whether to transmit a portion of the PSSCH transmission via a subset of LBT sub-bands of the set of multiple LBT sub-bands based on at least one LBT procedure of the respective LBT procedures failing and based on first sidelink control information and second sidelink control information associated with the PSSCH transmission both being included in a first LBT sub-band of the set of multiple LBT sub-bands. The operations of 1515 may be performed in accordance with examples as disclosed herein. In some examples, aspects of the operations of 1515 may be performed by a transmission determination component 1235 as described with reference to FIG. 12.

At 1520, the method may include transmitting the portion of the PSSCH transmission via the subset of LBT sub-bands, the subset of LBT sub-bands including the first LBT sub-band, where the portion of the PSSCH transmission is transmitted based on successful LBT procedures for each LBT sub-band of the subset of LBT sub-bands, and where the at least one LBT procedure that failed corresponds to one or more LBT sub-bands that are different from LBT sub-bands of the subset of LBT sub-bands. The operations of 1520 may be performed in accordance with examples as disclosed herein. In some examples, aspects of the operations of 1520 may be performed by a transmission component 1240 as described with reference to FIG. 12.

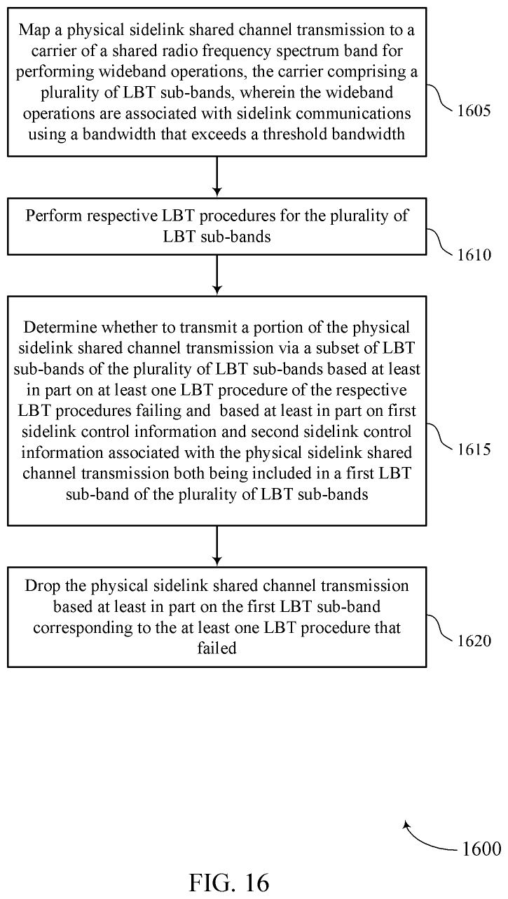

FIG. 16 shows a flowchart illustrating a method 1600 that supports mapping techniques for partial sidelink transmissions using wideband operations in accordance with one or more aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1605, the method may include mapping a PSSCH transmission to a carrier of a shared radio frequency spectrum band for performing wideband operations, the carrier including a set of multiple LBT sub-bands, where the wideband operations are associated with sidelink communications using a bandwidth that exceeds a threshold bandwidth. The operations of 1605 may be performed in accordance with examples as disclosed herein. In some examples, aspects of the operations of 1605 may be performed by a mapping component 1225 as described with reference to FIG. 12.

At 1610, the method may include performing respective LBT procedures for the set of multiple LBT sub-bands. The operations of 1610 may be performed in accordance with examples as disclosed herein. In some examples, aspects of the operations of 1610 may be performed by an LBT component 1230 as described with reference to FIG. 12.

At 1615, the method may include determining whether to transmit a portion of the PSSCH transmission via a subset of LBT sub-bands of the set of multiple LBT sub-bands based on at least one LBT procedure of the respective LBT procedures failing and based on first sidelink control information and second sidelink control information associated with the PSSCH transmission both being included in a first LBT sub-band of the set of multiple LBT sub-bands. The operations of 1615 may be performed in accordance with examples as disclosed herein. In some examples, aspects of the operations of 1615 may be performed by a transmission determination component 1235 as described with reference to FIG. 12.

At 1620, the method may include dropping the PSSCH transmission based on the first LBT sub-band corresponding to the at least one LBT procedure that failed. The operations of 1620 may be performed in accordance with examples as disclosed herein. In some examples, aspects of the operations of 1620 may be performed by a dropping component 1250 as described with reference to FIG. 12.

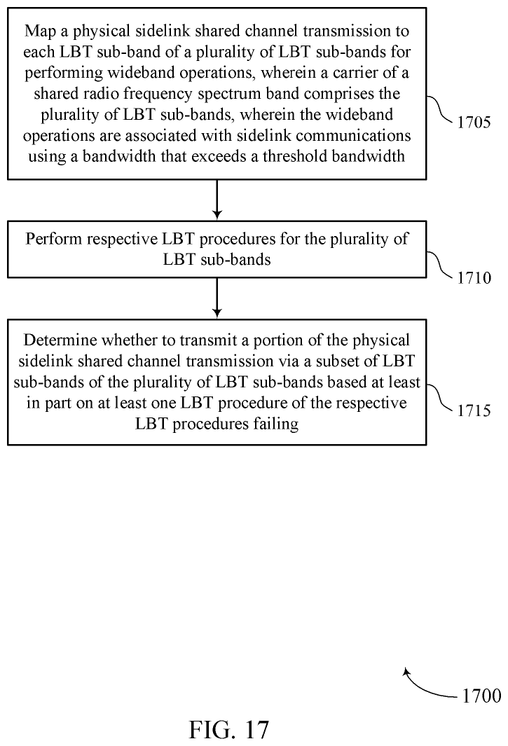

FIG. 17 shows a flowchart illustrating a method 1700 that supports mapping techniques for partial sidelink transmissions using wideband operations in accordance with one or more aspects of the present disclosure. The operations of the method 1700 may be implemented by a UE or its components as described herein. For example, the operations of the method 1700 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1705, the method may include mapping a PSSCH transmission to each LBT sub-band of a set of multiple LBT sub-bands for performing wideband operations, where a carrier of a shared radio frequency spectrum band includes the set of multiple LBT sub-bands, where the wideband operations are associated with sidelink communications using a bandwidth that exceeds a threshold bandwidth. The operations of 1705 may be performed in accordance with examples as disclosed herein. In some examples, aspects of the operations of 1705 may be performed by a mapping component 1225 as described with reference to FIG. 12.

At 1710, the method may include performing respective LBT procedures for the set of multiple LBT sub-bands. The operations of 1710 may be performed in accordance with examples as disclosed herein. In some examples, aspects of the operations of 1710 may be performed by an LBT component 1230 as described with reference to FIG. 12.

At 1715, the method may include determining whether to transmit a portion of the PSSCH transmission via a subset of LBT sub-bands of the set of multiple LBT sub-bands based on at least one LBT procedure of the respective LBT procedures failing. The operations of 1715 may be performed in accordance with examples as disclosed herein. In some examples, aspects of the operations of 1715 may be performed by a transmission determination component 1235 as described with reference to FIG. 12.

The following provides an overview of aspects of the present disclosure:

Aspect 1: A method for wireless communication at a UE, comprising: mapping a physical sidelink shared channel transmission to a carrier of a shared radio frequency spectrum band for performing wideband operations, the carrier comprising a plurality of LBT sub-bands, wherein the wideband operations are associated with sidelink communications using a bandwidth that exceeds a threshold bandwidth; performing respective LBT procedures for the plurality of LBT sub-bands; and determining whether to transmit a portion of the physical sidelink shared channel transmission via a subset of LBT sub-bands of the plurality of LBT sub-bands based at least in part on at least one LBT procedure of the respective LBT procedures failing.

Aspect 2: The method of aspect 1, wherein determining whether to transmit the portion of the physical sidelink shared channel transmission comprises: determining whether to transmit the portion of the physical sidelink shared channel transmission based at least in part on first sidelink control information and second sidelink control information associated with the physical sidelink shared channel transmission both being included in a first LBT sub-band of the plurality of LBT sub-bands.

Aspect 3: The method of aspect 2, further comprising: transmitting the portion of the physical sidelink shared channel transmission via the subset of LBT sub-bands, the subset of LBT sub-bands including the first LBT sub-band, wherein the portion of the physical sidelink shared channel transmission is transmitted based at least in part on successful LBT procedures for each LBT sub-band of the subset of LBT sub-bands, and wherein the at least one LBT procedure that failed corresponds to one or more LBT sub-bands that are different from LBT sub-bands of the subset of LBT sub-bands.

Aspect 4: The method of aspect 3, wherein the portion of the physical sidelink shared channel transmission is transmitted based at least in part on a quantity of LBT sub-bands of the subset of LBT sub-bands satisfying a threshold quantity of LBT sub-bands having a successful LBT procedure.

Aspect 5: The method of aspect 2, further comprising: dropping the physical sidelink shared channel transmission based at least in part on the first LBT sub-band corresponding to the at least one LBT procedure that failed.

Aspect 6: The method of aspect 1, wherein determining whether to transmit the portion of the physical sidelink shared channel transmission comprises: determining whether to transmit the portion of the physical sidelink shared channel transmission based at least in part on first sidelink control information and second sidelink control information associated with the physical sidelink shared channel transmission being included in each LBT sub-band of the plurality of LBT sub-bands.

Aspect 7: The method of aspect 6, further comprising: transmitting the portion of the physical sidelink shared channel transmission via the subset of LBT sub-bands based at least in part on a first quantity of LBT sub-bands of the subset of LBT sub-bands satisfying a threshold quantity of LBT sub-bands having a successful LBT procedure.

Aspect 8: The method of aspect 6, further comprising: dropping the physical sidelink shared channel transmission based at least in part on a second quantity of LBT sub-bands of the plurality of LBT sub-bands failing to satisfy a threshold quantity of LBT sub-bands having a successful LBT procedure.

Aspect 9: The method of aspect 1, wherein determining whether to transmit the portion of the physical sidelink shared channel transmission comprises: determining whether to transmit the portion of the physical sidelink shared channel transmission based at least in part on first sidelink control information associated with the physical sidelink shared channel transmission being included in a first LBT sub-band of the plurality of LBT sub-bands and second sidelink control information associated with the physical sidelink shared channel transmission being included in two or more LBT sub-bands of the plurality of LBT sub-bands.

Aspect 10: The method of aspect 9, further comprising: transmitting the portion of the physical sidelink shared channel transmission via the subset of LBT sub-bands, the subset of LBT sub-bands including the first LBT sub-band, wherein the portion of the physical sidelink shared channel transmission is transmitted based at least in part on successful LBT procedures for each LBT sub-band of the subset of LBT sub-bands and a threshold percentage of the second sidelink control information being included in LBT sub-bands having the successful LBT procedures.

Aspect 11: The method of aspect 10, wherein the portion of the physical sidelink shared channel transmission is transmitted based at least in part on a quantity of LBT sub-bands of the subset of LBT sub-bands satisfying a threshold quantity of LBT sub-bands having a successful LBT procedure.

Aspect 12: The method of aspect 9, further comprising: dropping the physical sidelink shared channel transmission based at least in part on a threshold percentage of the second sidelink control information being included in the at least one LBT sub-band that failed the LBT procedure.

Aspect 13: The method of any of aspects 1 through 12, wherein mapping the physical sidelink shared channel transmission comprises: mapping the physical sidelink shared channel transmission across the plurality of LBT sub-bands of the carrier, wherein the physical sidelink shared channel transmission is mapped based at least in part on a frequency index of the carrier followed by a time index of the carrier.

Aspect 14: A method for wireless communication, comprising: mapping a physical sidelink shared channel transmission to each LBT sub-band of a plurality of LBT sub-bands for performing wideband operations, wherein a carrier of a shared radio frequency spectrum band comprises the plurality of LBT sub-bands, wherein the wideband operations are associated with sidelink communications using a bandwidth that exceeds a threshold bandwidth; performing respective LBT procedures for the plurality of LBT sub-bands; and determining whether to transmit a portion of the physical sidelink shared channel transmission via a subset of LBT sub-bands of the plurality of LBT sub-bands based at least in part on at least one LBT procedure of the respective LBT procedures failing.

Aspect 15: The method of aspect 14, wherein mapping the physical sidelink shared channel transmission comprises: mapping a different redundancy version of a transport block associated with the physical sidelink shared channel transmission to respective LBT sub-bands of the plurality of LBT sub-bands, wherein the mapping is based at least in part on a modulation and coding scheme for the physical sidelink shared channel transmission.

Aspect 16: The method of aspect 15, wherein determining whether to transmit the portion of the physical sidelink shared channel transmission comprises: determining whether to transmit the portion of the physical sidelink shared channel transmission based at least in part on first sidelink control information and second sidelink control information associated with the physical sidelink shared channel transmission both being included in a first LBT sub-band of the plurality of LBT sub-bands.

Aspect 17: The method of aspect 16, further comprising: transmitting the portion of the physical sidelink shared channel transmission via the subset of LBT sub-bands, the subset of LBT sub-bands including the first LBT sub-band, wherein the portion of the physical sidelink shared channel transmission is transmitted based at least in part on successful LBT procedures for each LBT sub-band of the subset of LBT sub-bands, and wherein the at least one LBT procedure that failed corresponds to one or more LBT sub-bands that are different from LBT sub-bands of the subset of LBT sub-bands.

Aspect 18: The method of aspect 16, further comprising: dropping the physical sidelink shared channel transmission based at least in part on the first LBT sub-band corresponding to the at least one LBT procedure that failed.

Aspect 19: The method of aspect 15, wherein determining whether to transmit the portion of the physical sidelink shared channel transmission comprises: determining whether to transmit the portion of the physical sidelink shared channel transmission based at least in part on first sidelink control information associated with the physical sidelink shared channel transmission being included in a first LBT sub-band of the plurality of LBT sub-bands and second sidelink control information associated with the physical sidelink shared channel transmission being included in two or more LBT sub-bands of the plurality of LBT sub-bands.

Aspect 20: The method of aspect 19, further comprising: transmitting the portion of the physical sidelink shared channel transmission via the subset of LBT sub-bands, the subset of LBT sub-bands including the first LBT sub-band, wherein the portion of the physical sidelink shared channel transmission is transmitted based at least in part on successful LBT procedures for each LBT sub-band of the subset of LBT sub-bands and a threshold percentage of the second sidelink control information being included in LBT sub-bands having the successful LBT procedures.

Aspect 21: The method of aspect 19, further comprising: dropping the physical sidelink shared channel transmission based at least in part on a threshold percentage of the second sidelink control information being included in the at least one LBT sub-band that failed the LBT procedure.

Aspect 22: The method of aspect 15, wherein determining whether to transmit the portion of the physical sidelink shared channel transmission comprises: determining whether to transmit the portion of the physical sidelink shared channel transmission based at least in part on first sidelink control information and second sidelink control information associated with the physical sidelink shared channel transmission being included in each LBT sub-band of the plurality of LBT sub-bands.

Aspect 23: The method of aspect 22, further comprising: transmitting the portion of the physical sidelink shared channel transmission via the subset of LBT sub-bands based at least in part on successful LBT procedures for LBT sub-bands of the subset of LBT sub-bands.

Aspect 24: The method of aspect 22, further comprising: dropping the physical sidelink shared channel transmission based at least in part on failed LBT procedures for LBT sub-bands of the plurality of LBT sub-bands.

Aspect 25: The method of any of aspects 15 through 24, wherein the different redundancy versions of the transport block are mapped to the respective LBT sub-bands based at least in part on a predefined mapping rule.

Aspect 26: The method of aspect 15, further comprising: transmitting, in each LBT sub-band of the plurality of LBT sub-bands, first sidelink control information and second sidelink control information associated with the physical sidelink shared channel transmission, the second sidelink control information indicating a redundancy version corresponding to the respective LBT sub-band that includes the second sidelink control information.

Aspect 27: The method of aspect 14, wherein mapping the physical sidelink shared channel transmission comprises: mapping a different transport block associated with the physical sidelink shared channel transmission to respective LBT sub-bands of the plurality of LBT sub-bands.

Aspect 28: The method of aspect 27, wherein each LBT sub-band of the plurality of LBT sub-bands includes a respective set of first sidelink control information and second sidelink control information associated with the physical sidelink shared channel transmission, each set of first sidelink control information and second sidelink control information indicates a respective transport block associated with an LBT sub-band.

Aspect 29: The method of aspect 27, wherein a first LBT sub-band of the plurality of LBT sub-bands includes first sidelink control information and each LBT sub-band of the plurality of LBT sub-bands includes a respective second sidelink control information, the first sidelink control information indicating a modulation and coding scheme and a resource allocation for the carrier, and each second sidelink control information indicating one or more information fields for a respective transport block of the one or more transport blocks.

Aspect 30: The method of aspect 29, wherein the resource allocation is based at least in part on a quantity of LBT sub-bands of the plurality of sub-bands or a ratio of available frequency resources of the carrier.

Aspect 31: The method of aspect 29, wherein the second sidelink control information indicates a resource allocation for each LBT sub-band of the plurality of LBT sub-bands.

Aspect 32: The method of aspect 14, wherein mapping the physical sidelink shared channel transmission comprises: mapping a respective sets of code block groups of a transport block associated with the physical sidelink shared channel transmission to respective LBT sub-bands of the plurality of LBT sub-bands.

Aspect 33: The method of aspect 32, wherein a first LBT sub-band of the plurality of LBT sub-bands includes first sidelink control information and each LBT sub-band of the plurality of LBT sub-bands includes a respective second sidelink control information, the method further comprising: transmitting the portion of the physical sidelink shared channel transmission via the subset of LBT sub-bands based at least in part on successful LBT procedures for the first LBT sub-band, the subset of LBT sub-bands including the first LBT sub-band.

Aspect 34: The method of any of aspects 32 through 33, wherein a threshold quantity of code block groups in each set of code block groups is based at least in part on an integer multiple of a quantity of LBT sub-bands of the plurality of LBT sub-bands.

Aspect 35: The method of any of aspects 14 through 34, further comprising: transmitting at least the portion of the physical sidelink shared channel transmission; and receiving, via one or more physical sidelink feedback channels, a feedback message that indicates whether the physical sidelink shared channel transmission was decoded by another UE, wherein the feedback message comprises a single bit or multiple bits to indicate whether the physical sidelink shared channel transmission was decoded based at least in part on the mapping of the physical sidelink shared channel transmission.

Aspect 36: The method of aspect 35, wherein the feedback message comprises the multiple bits, and the multiple bits are included in a single physical sidelink feedback channel.

Aspect 37: The method of aspect 35, wherein the feedback message comprises the multiple bits, and each bit of the multiple bits are included in a respective physical sidelink feedback channel.

Aspect 38: The method of any of aspects 35 through 37, wherein receiving the feedback message comprises: receiving the feedback message via a set of physical sidelink feedback channel resources that are from a resource pool that is based on the wideband operations.

Aspect 39: The method of any of aspects 35 through 38, wherein receiving the feedback message comprises: receiving the feedback message via a respective sets of physical sidelink feedback channel resources that are from different resource pools corresponding to the respective LBT sub-bands of the plurality of LBT sub-bands.

Aspect 40: An apparatus for wireless communication at a UE, comprising a processor; memory coupled with the processor; and instructions stored in the memory and executable by the processor to cause the apparatus to perform a method of any of aspects 1 through 13.

Aspect 41: An apparatus for wireless communication at a UE, comprising at least one means for performing a method of any of aspects 1 through 13.

Aspect 42: A non-transitory computer-readable medium storing code for wireless communication at a UE, the code comprising instructions executable by a processor to perform a method of any of aspects 1 through 13.

Aspect 43: An apparatus for wireless communication, comprising a processor; memory coupled with the processor; and instructions stored in the memory and executable by the processor to cause the apparatus to perform a method of any of aspects 14 through 39.

Aspect 44: An apparatus for wireless communication, comprising at least one means for performing a method of any of aspects 14 through 39.

Aspect 45: A non-transitory computer-readable medium storing code for wireless communication, the code comprising instructions executable by a processor to perform a method of any of aspects 14 through 39.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
mapping a physical sidelink shared channel transmission to a carrier of a shared radio frequency spectrum band for performing wideband operations, the carrier comprising a plurality of listen-before-talk (LBT) sub-bands, wherein the wideband operations are associated with sidelink communications using a bandwidth that exceeds a threshold bandwidth;
performing respective LBT procedures for the plurality of LBT sub-bands; and
determining whether to transmit a portion of the physical sidelink shared channel transmission via a subset of LBT sub-bands of the plurality of LBT sub-bands based at least in part on at least one LBT procedure of the respective LBT procedures failing.

2. The method of claim 1, wherein determining whether to transmit the portion of the physical sidelink shared channel transmission comprises:
determining whether to transmit the portion of the physical sidelink shared channel transmission based at least in part on first sidelink control information and second sidelink control information associated with the physical sidelink shared channel transmission both being included in a first LBT sub-band of the plurality of LBT sub-bands.

3. The method of claim 2, further comprising:
transmitting the portion of the physical sidelink shared channel transmission via the subset of LBT sub-bands, the subset of LBT sub-bands including the first LBT sub-band, wherein the portion of the physical sidelink shared channel transmission is transmitted based at least in part on successful LBT procedures for each LBT sub-band of the subset of LBT sub-bands, and wherein the at least one LBT procedure that failed corresponds to one or more LBT sub-bands that are different from LBT sub-bands of the subset of LBT sub-bands.

4. The method of claim 3, wherein the portion of the physical sidelink shared channel transmission is transmitted based at least in part on a quantity of LBT sub-bands of the subset of LBT sub-bands satisfying a threshold quantity of LBT sub-bands having a successful LBT procedure.

5. The method of claim 2, further comprising:
dropping the physical sidelink shared channel transmission based at least in part on the first LBT sub-band corresponding to the at least one LBT procedure that failed.

6. The method of claim 1, wherein determining whether to transmit the portion of the physical sidelink shared channel transmission comprises:
determining whether to transmit the portion of the physical sidelink shared channel transmission based at least in part on first sidelink control information and second sidelink control information associated with the physical sidelink shared channel transmission being included in each LBT sub-band of the plurality of LBT sub-bands.

7. The method of claim 6, further comprising:
transmitting the portion of the physical sidelink shared channel transmission via the subset of LBT sub-bands based at least in part on a first quantity of LBT sub-bands of the subset of LBT sub-bands satisfying a threshold quantity of LBT sub-bands having a successful LBT procedure.

8. The method of claim 6, further comprising:
dropping the physical sidelink shared channel transmission based at least in part on a second quantity of LBT sub-bands of the plurality of LBT sub-bands failing to satisfy a threshold quantity of LBT sub-bands having a successful LBT procedure.

9. The method of claim 1, wherein determining whether to transmit the portion of the physical sidelink shared channel transmission comprises:
determining whether to transmit the portion of the physical sidelink shared channel transmission based at least in part on first sidelink control information associated with the physical sidelink shared channel transmission being included in a first LBT sub-band of the plurality of LBT sub-bands and second sidelink control information associated with the physical sidelink shared channel transmission being included in two or more LBT sub-bands of the plurality of LBT sub-bands.

10. The method of claim 9, further comprising:
transmitting the portion of the physical sidelink shared channel transmission via the subset of LBT sub-bands, the subset of LBT sub-bands including the first LBT sub-band, wherein the portion of the physical sidelink shared channel transmission is transmitted based at least in part on successful LBT procedures for each LBT sub-band of the subset of LBT sub-bands and a threshold percentage of the second sidelink control information being included in LBT sub-bands having the successful LBT procedures.

11. The method of claim 10, wherein the portion of the physical sidelink shared channel transmission is transmitted based at least in part on a quantity of LBT sub-bands of the subset of LBT sub-bands satisfying a threshold quantity of LBT sub-bands having a successful LBT procedure.

12. The method of claim 9, further comprising:
dropping the physical sidelink shared channel transmission based at least in part on a threshold percentage of the second sidelink control information being included in the at least one LBT sub-band that failed the LBT procedure.

13. The method of claim 1, wherein mapping the physical sidelink shared channel transmission comprises:
mapping the physical sidelink shared channel transmission across the plurality of LBT sub-bands of the carrier, wherein the physical sidelink shared channel transmission is mapped based at least in part on a frequency index of the carrier followed by a time index of the carrier.

14. A method for wireless communication, comprising:
mapping a physical sidelink shared channel transmission to each listen-before-talk (LBT) sub-band of a plurality of LBT sub-bands for performing wideband operations, wherein a carrier of a shared radio frequency spectrum band comprises the plurality of LBT sub-bands, wherein the wideband operations are associated with sidelink communications using a bandwidth that exceeds a threshold bandwidth;
performing respective LBT procedures for the plurality of LBT sub-bands; and
determining whether to transmit a portion of the physical sidelink shared channel transmission via a subset of LBT sub-bands of the plurality of LBT sub-bands based at least in part on at least one LBT procedure of the respective LBT procedures failing.

15. The method of claim 14, wherein mapping the physical sidelink shared channel transmission comprises:
mapping a different redundancy version of a transport block associated with the physical sidelink shared channel transmission to respective LBT sub-bands of the plurality of LBT sub-bands, wherein the mapping is based at least in part on a modulation and coding scheme for the physical sidelink shared channel transmission.

16. The method of claim 15, wherein determining whether to transmit the portion of the physical sidelink shared channel transmission comprises:
determining whether to transmit the portion of the physical sidelink shared channel transmission based at least in part on first sidelink control information and second sidelink control information associated with the physical sidelink shared channel transmission both being included in a first LBT sub-band of the plurality of LBT sub-bands.

17. The method of claim 15, wherein determining whether to transmit the portion of the physical sidelink shared channel transmission comprises:
determining whether to transmit the portion of the physical sidelink shared channel transmission based at least in part on first sidelink control information associated with the physical sidelink shared channel transmission being included in a first LBT sub-band of the plurality of LBT sub-bands and second sidelink control information associated with the physical sidelink shared channel transmission being included in two or more LBT sub-bands of the plurality of LBT sub-bands.

18. The method of claim 15, wherein determining whether to transmit the portion of the physical sidelink shared channel transmission comprises:
determining whether to transmit the portion of the physical sidelink shared channel transmission based at least in part on first sidelink control information and second sidelink control information associated with the physical sidelink shared channel transmission being included in each LBT sub-band of the plurality of LBT sub-bands.

19. The method of claim 15, wherein the different redundancy versions of the transport block are mapped to the respective LBT sub-bands based at least in part on a predefined mapping rule.

20. The method of claim 15, further comprising:
transmitting, in each LBT sub-band of the plurality of LBT sub-bands, first sidelink control information and second sidelink control information associated with the physical sidelink shared channel transmission, the second sidelink control information indicating a redundancy version corresponding to the respective LBT sub-band that includes the second sidelink control information.

21. The method of claim 14, wherein mapping the physical sidelink shared channel transmission comprises:
mapping a different transport block associated with the physical sidelink shared channel transmission to respective LBT sub-bands of the plurality of LBT sub-bands.

22. The method of claim 21, wherein:
each LBT sub-band of the plurality of LBT sub-bands includes a respective set of first sidelink control information and second sidelink control information associated with the physical sidelink shared channel transmission; and
each set of first sidelink control information and second sidelink control information indicates a respective transport block associated with an LBT sub-band.

23. The method of claim 21, wherein a first LBT sub-band of the plurality of LBT sub-bands includes first sidelink control information and each LBT sub-band of the plurality of LBT sub-bands includes a respective second sidelink control information, the first sidelink control information indicating a modulation and coding scheme and a resource allocation for the carrier, and each second sidelink control information indicating one or more information fields for a respective transport block of the one or more transport blocks.

24. The method of claim 14, wherein mapping the physical sidelink shared channel transmission comprises:
mapping a respective sets of code block groups of a transport block associated with the physical sidelink shared channel transmission to respective LBT sub-bands of the plurality of LBT sub-bands.

25. The method of claim 24, wherein a first LBT sub-band of the plurality of LBT sub-bands includes first sidelink control information and each LBT sub-band of the plurality of LBT sub-bands includes a respective second sidelink control information, the method further comprising:
transmitting the portion of the physical sidelink shared channel transmission via the subset of LBT sub-bands based at least in part on successful LBT procedures for the first LBT sub-band, the subset of LBT sub-bands including the first LBT sub-band.

26. The method of claim 14, further comprising:
transmitting at least the portion of the physical sidelink shared channel transmission; and
receiving, via one or more physical sidelink feedback channels, a feedback message that indicates whether the physical sidelink shared channel transmission was decoded by another UE, wherein the feedback message comprises a single bit or multiple bits to indicate whether the physical sidelink shared channel transmission was decoded based at least in part on the mapping of the physical sidelink shared channel transmission.

27. The method of claim 26, wherein:
the feedback message comprises the multiple bits, and
the multiple bits are included in a single physical sidelink feedback channel or each bit of the multiple bits are included in a respective physical sidelink feedback channel.

28. The method of claim 26, wherein receiving the feedback message comprises:
receiving the feedback message via a set of physical sidelink feedback channel resources that are from a resource pool that is based on the wideband operations; or
receiving the feedback message via a respective sets of physical sidelink feedback channel resources that are from different resource pools corresponding to the respective LBT sub-bands of the plurality of LBT sub-bands.

29. An apparatus for wireless communication at a user equipment (UE), comprising:
a processor;
memory coupled with the processor; and
instructions stored in the memory and executable by the processor to cause the apparatus to:
map a physical sidelink shared channel transmission to a carrier of a shared radio frequency spectrum band for performing wideband operations, the carrier comprising a plurality of listen-before-talk (LBT) sub-bands, wherein the wideband operations are associated with sidelink communications using a bandwidth that exceeds a threshold bandwidth;
perform respective LBT procedures for the plurality of LBT sub-bands; and
determine whether to transmit a portion of the physical sidelink shared channel transmission via a subset of LBT sub-bands of the plurality of LBT sub-bands based at least in part on at least one LBT procedure of the respective LBT procedures failing.

30. An apparatus for wireless communication, comprising:
a processor;
memory coupled with the processor, and
instructions stored in the memory and executable by the processor to cause the apparatus to:
map a physical sidelink shared channel transmission to each listen-before-talk (LBT) sub-band of a plurality of LBT sub-bands for performing wideband operations, wherein a carrier of a shared radio frequency spectrum band comprises the plurality of LBT sub-bands, wherein the wideband operations are associated with sidelink communications using a bandwidth that exceeds a threshold bandwidth;
perform respective LBT procedures for the plurality of LBT sub-bands; and
determine whether to transmit a portion of the physical sidelink shared channel transmission via a subset of LBT sub-bands of the plurality of LBT sub-bands based at least in part on at least one LBT procedure of the respective LBT procedures failing.
